(19) United States
(12) Patent Application Publication
(10) Pub. No.: US 2026/0346339 A1
(43) Pub. Date: Nov. 5, 2026

(54) APPARATUS, SYSTEMS, AND METHODS FOR MONITORING, REGRESSION ANALYSIS USING CALCULATION OF PHASE DIAGRAM-BASED DATA MINING FOR CONTROLLING SINTERING PROCESSES IN POWDERED METALLURGY

(71) Applicants: General Electric Company, Evendale, OH (US); UT-BATTELLE, Oak Ridge, TN (US)

(72) Inventors: Rajendra M. Kelkar, Mason, OH (US); Peeyush Nandwana, Knoxville, TN (US); Rangasayee Kannan, Knoxville, TN (US)

(21) Appl. No.: 19/483,918

(22) PCT Filed: May 13, 2024
(86) PCT No.: PCT/US2024/029046

§ 371 Date: Nov. 12, 2025

Related U.S. Application Data
(60) Provisional application No. 63/465,893, filed on May 12, 2023.

(51) Int. Cl. B22F 10/85; B22F 10/14; B22F 10/31; B33Y 30/00; B33Y 50/02; G06F 30/27; G06F 113/10; G06F 119/18

(52) U.S. Cl. CPC B22F 10/85; B22F 10/14; B22F 10/31; B33Y 50/02; G06F 30/27; B22F 2203/11; B22F 2301/15; B22F 2301/35; B33Y 30/00; G06F 2113/10; G06F 2119/18

(57) ABSTRACT

Systems, apparatus, computer-readable medium, and associated methods to monitor, analyze, and adjust sintering window and associated sintering parameters are disclosed. Certain examples determine parameters for sintering and, if an error is detected, trigger a corrective action before proceeding with the sintering operation. An example apparatus is to: generate a plurality of material compositions within specified bounds; calculate a delta phase stability using thermo-kinetic calculations for the plurality of material compositions at a plurality of temperatures; train an artificial intelligence model using the delta phase stability, plurality of temperatures, and plurality of compositions; and configure a sintering process for a part formed of one of the plurality of material compositions using an inference output of the artificial intelligence model.

### CROSS-REFERENCE TO RELATED APPLICATIONS

This patent arises from U.S. Provisional Patent Application Ser. No. 63/465,893, which was filed on May 12, 2023. U.S. Provisional Patent Application Ser. No. 63/465,893 is hereby incorporated herein by reference in its entirety. Priority to U.S. Provisional Patent Application Ser. No. 63/465,893 is hereby claimed.

### STATEMENT REGARDING FEDERALLY SPONSORED RESEARCH AND DEVELOPMENT

The technologies described herein were developed with government support under Contract No. DE-AC05-00OR22725 awarded by the U.S. Department of Energy. The government has certain rights in the described technologies.

### FIELD

The present disclosure relates to systems and methods for additive manufacturing, and more specifically, for controlling sintering processes in powdered metallurgical additive manufacturing.

### BACKGROUND

Three-dimensional objects can be additively manufactured using an additive manufacturing machine. One type of additive manufacturing machine is a binder jet. In binder jet additive manufacturing, a liquid binder is used to join particles of a powder (e.g., a metallic powder) to form a three-dimensional object. For example, a controlled pattern of the liquid binder is applied to successive layers of the powder in a powder bed such that the layers of the material adhere to one another to form a three-dimensional “green” part. Through subsequent processing (e.g., sintering), the three-dimensional green part can be formed into a finished three-dimensional part.

### BRIEF DESCRIPTION OF THE DRAWINGS

A full and enabling disclosure, including the best mode thereof, directed to one of ordinary skill in the art, is set forth in the specification, which makes reference to the appended figures, in which:

FIG. 1 schematically depicts an example additive manufacturing system in accordance with examples of the present disclosure.

FIG. 2 schematically depicts the example additive manufacturing system of FIG. 1 further including a de-powdering system and a sintering furnace in accordance with examples of the present disclosure.

FIG. 3 shows an example sintering window.

FIG. 4 is a flow diagram of a prior process to determine a sintering window.

FIG. 5 is a flow diagram of an example process to determine a sintering window.

FIG. 6 is a flow diagram of an example process to train and deploy a model to determine and configure an additive manufacturing system according to a delta phase fraction and sintering window.

FIG. 7 depicts a distribution of elemental composition for variations of an example Inconel 718 alloy composition.

FIG. 8 shows an example correlation matrix between composition and temperature.

FIG. 9 illustrates an example graph of delta phase stability at different temperatures for different compositions.

FIG. 10 is a graph showing an example distribution of data points used in training a regression model.

FIG. 11a shows a regression training example for a random forest regression model.

FIG. 11b shows a regression training example for a gradient boosting regression model.

FIG. 11c shows a regression training example for an XGBoost regression model.

FIG. 11d shows a regression training example for a neural network regression model.

FIG. 12 is a graph of example regression model validation.

FIG. 13 illustrates an example graphical user interface tool.

FIG. 14 illustrates an example implementation of the process of FIG. 6 for a plurality of temperatures.

FIG. 15a shows example variation in cross-validation score for a random forest regression model.

FIG. 15b shows example variation in cross-validation score for a gradient boosting regression model.

FIG. 15c shows example variation in cross-validation score for an XGBoost regression model.

FIG. 15d shows example variation in cross-validation score for a neural network regression model.

FIG. 16a compares predicted values from the regression models and estimated solidus temperature values from thermo-kinetic analysis for the alloys.

FIG. 16b compares predicted values from the regression models and estimated liquidus temperature values from thermo-kinetic analysis for the alloys.

FIG. 16c represents experimentally reported distortion temperatures with the regression model predicted distortion temperature for a variety of alloys.

FIG. 17 is an example sintering control system or circuit.

FIG. 18 is a block diagram of an example processing platform including processor circuitry structured to execute the example machine readable instructions of FIGS. 5, 6, and 14 to implement the example sintering control circuit of FIG. 17.

FIG. 19 is a block diagram of an example implementation of the processor circuitry of FIG. 18.

FIG. 20 is a block diagram of another example implementation of the processor circuitry of FIG. 19.

The figures are not to scale. Instead, the thickness of the layers or regions may be enlarged in the drawings. In general, the same reference numbers will be used throughout the drawing(s) and accompanying written description to refer to the same or like parts. As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. Stating that any part is in “contact” with another part means that there is no intermediate part between the two parts.

### DETAILED DESCRIPTION

Certain examples provide improved additive manufacturing and associated monitoring and control. Certain examples improve sintering in binder jet additive manufacturing through determination of an optimal or otherwise improved sintering window in the binder jet additive manufacturing process and corresponding configuration of the additive manufacturing machine to operate accordingly in the sintering window.

Descriptors “first,” “second,” “third,” etc. are used herein when identifying multiple elements or components which may be referred to separately. Unless otherwise specified or understood based on their context of use, such descriptors are not intended to impute any meaning of priority, physical order, or arrangement in a list, or ordering in time but are merely used as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

As used herein, the terms “system,” “unit,” “module,” “engine,” “component,” etc., may include a hardware and/or software system that operates to perform one or more functions. For example, a module, unit, or system may include a computer processor, controller, and/or other logic-based device that performs operations based on instructions stored on a tangible and non-transitory computer readable storage medium, such as a computer memory. Alternatively, a module, unit, or system may include a hard-wires device that performs operations based on hardwired logic of the device. Various modules, units, engines, and/or systems shown in the attached figures may represent the hardware that operates based on software or hardwired instructions, the software that directs hardware to perform the operations, or a combination thereof.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 1, 2, 4, 10, 15, or 20 percent margin. These approximating margins may apply to a single value, either or both endpoints defining numerical ranges, and/or the margin for ranges between endpoints.

As used herein, the terms “additively manufactured” or “additive manufacturing techniques or processes” refer generally to manufacturing processes in which successive layers of material(s) are provided on each other to “build-up,” layer-by-layer, a three-dimensional component. The successive layers generally fuse together to form a monolithic component which may have a variety of integral sub-components. Although additive manufacturing technology is described herein as enabling fabrication of complex objects by building objects point-by-point, layer-by-layer, typically in a vertical direction, other methods of fabrication are possible and within the scope of the present disclosure.

Suitable additive manufacturing techniques in accordance with the present disclosure include, for example, Fused Deposition Modeling (FDM), Selective Laser Sintering (SLS), 3D printing such as by inkjets, laser jets, and binder jets, Stereolithography (SLA), Direct Selective Laser Sintering (DSLS), Electron Beam Sintering (EBS), Electron Beam Melting (EBM), Laser Engineered Net Shaping (LENS), Laser Net Shape Manufacturing (LNSM), Direct Metal Deposition (DMD), Digital Light Processing (DLP), Direct Selective Laser Melting (DSLM), Selective Laser Melting (SLM), Direct Metal Laser Melting (DMLM), and other known processes.

The additive manufacturing processes described herein may be used for forming components using any suitable material. For example, the material may be plastic, metal, concrete, ceramic, polymer, epoxy, photopolymer resin, or any other suitable material that may be in solid, liquid, powder, sheet material, wire, or any other suitable form or combinations thereof. More specifically, according to certain examples described herein, the additively manufactured components described herein may be formed in part, in whole, or in some combination of materials including but not limited to pure metals, nickel alloys, chrome alloys, titanium, titanium alloys, magnesium, magnesium alloys, aluminum, aluminum alloys, and nickel or cobalt based superalloys (e.g., cobalt chrome, alloys available under the name Inconel® available from Special Metals Corporation, etc.), stainless steel (e.g., stainless steel 316, etc.). These materials are examples of materials suitable for use in the additive manufacturing processes described herein and may be generally referred to as “additive materials.”

In addition, one skilled in the art will appreciate that a variety of materials and methods for bonding those materials may be used and are contemplated as within the scope of the present disclosure. As used herein, references to “fusing” may refer to any suitable process for creating a bonded layer of any of the above materials. For example, if an object is made from polymer, fusing may refer to creating a thermoset bond between polymer materials. If the object is epoxy, the bond may be formed by a crosslinking process. If the material is ceramic, the bond may be formed by a sintering process. If the material is powdered metal, the bond may be formed by a melting or sintering process.

For example, in Nickel alloys, during de-binding (e.g., at temperatures between approximately 400 degrees Celsius (°C) and approximately 450 °C) a chemical binder used to form a green part is burned out, leaving a “brown” part that is mostly a metal powder bound by trace amounts of the chemical binder. Next, the brown part is subjected to different phases of sintering. During this window of time (the “sintering window”), the metal powder particles of the brown part start to neck during sintering at temperatures in excess of 1000 °C, depending on the metal powder used to fabricate the printed metal part. Additionally, diffusion takes over during long incubation times of sintering, which is typically between approximately 1280 °C and approximately 1300 °C for between approximately 6 hours and approximately 24 hours to close out most of the porosity in the metal part and produce parts between approximately 94% and approximately 99% density. One skilled in the art will appreciate that other methods of fusing materials to make a component by additive manufacturing are possible, and the presently disclosed subject matter may be practiced with those methods.

In addition, the additive manufacturing process disclosed herein allows a single component to be formed from multiple materials. Thus, the components described herein may be formed from any suitable mixtures of the above materials. For example, a component may include multiple layers, segments, or parts that are formed using different materials, processes, and/or on different additive manufacturing machines. In this manner, components may be constructed which have different materials and material properties for meeting the demands of any particular application. In addition, although the components described herein are constructed entirely by additive manufacturing processes, it should be appreciated that in alternate embodiments, all or a portion of these components may be formed via casting, machining, and/or any other suitable manufacturing process. Indeed, any suitable combination of materials and manufacturing methods may be used to form these components.

Binder jet additive manufacturing (BJAM) is a powder bed-based additive manufacturing process, which uses a liquid-based binding agent (binder) to selectively join material powders in the powder bed. Like other additive manufacturing techniques, BJAM offers design flexibility which enables manufacturing of complex parts.

BJAM operation can involve closed loop control of curing parameters, recoat parameters, jetting parameters, etc. Curing parameters (e.g., infrared (IR) lamp intensity, etc.) can be modified based on real-time (or substantially real-time) health (e.g., based on powder bed temperature, images, etc.). Recoat parameters (e.g., dosing factor, roller speed, etc.) can be modified based on real-time (or substantially real-time) health (e.g., based on powder bed temperature from IR camera, images, etc.). Jetting parameters (e.g., measure/modify saturation, manifold pressures, drop velocity, etc.) can be modified based on real-time health metrics (jetting quality, saturation, etc.) to enable detection, correction, and preventative measures. Other parameters, such as humidity, temperature, pressure, drive/pump current, and torque can affect binding speed, quality, saturation of binder into the powder bed, and overall part quality. Infrared (IR) lamps that cure each layer of a build can be monitored in conjunction with these parameters (e.g., higher humidity can affect cure time and saturation). Lower IR temperature resulting from lamp degradation can affect print time and overall quality, etc.

Since its inception, BJAM has been used to fabricate parts (e.g., preforms, complex parts, etc.) from variety of metallic alloys such as Inconel 625, Inconel 718, stainless steel 17-4PH, stainless steel 316L, other nickel/nickel-chromium alloys, other classes of stainless steel, and H13 tool steels. Following binder jetting, the printed parts are subjected to a binder burnout treatment to vaporize the organic binder and carbon rich residue since carbon (C) can adversely affect the sinterability and mechanical properties of sintered parts. With recent advancements in binder technology, binders have been developed which leave no carbon rich residue. After binder burnout, the preforms and/or other parts are heated to a sintering temperature to increase the density of the parts. Sintering can be performed at temperatures below a temperature at which alloys have completely solidified (referred to as the solidus temperature). For example, solid state sintering is performed below the solidus temperature, where densification occurs by diffusion and mass transport in the solid-state regime.

Recently, supersolidus liquid phase sintering (SLPS) has gathered attention owing to higher rates of densification. SLPS is a densification technique which involves sintering of prealloyed powders at a temperature between solidus and liquidus, which results in the nucleation of liquid phase at grain boundaries, inter-particle boundaries, and inside the grains. The densification is found to occur during: (i) liquid formation along grain boundaries/interparticle boundaries followed by (ii) particle fragmentation of the polycrystalline particles leading to densification by capillary rearrangement, and (iii) densification by solution-reprecipitation, pore removal, and grain-shape accommodation. The volume fraction of liquid formed at the sintering temperature is important to a successful build, since a too low liquid fraction at the sintering temperature can result in poor densification, while a high liquid volume fraction can result in distortion of the parts. Therefore, controlling the fraction of liquid formed during SLPS is used for the densification and shape retention of parts. An “ideal” sintering window results in the formation of sufficient liquid for densification but not too much liquid so that binder jet printed parts retain their shape. However, to date, there remains a need to quantifying the amount of liquid needed for densification without distortion.

At least for this reason, predicting the sintering window has previously been performed through a trial-and-error approach, resulting in extensive experimentation needed to define a sintering window for an alloy. Studies in literature have provided quantitative insights into the critical volume fraction of liquid beyond which distortion occurs (e.g., 40 vol. %), and defined distortion windows based on differential-scanning calorimeter readings, respectively. These quantities can be estimated using CALculation of PHAse Diagram (CALPHAD) software packages. Unlike other fusion based additive manufacturing (AM) techniques, the binder jetting and sintering process occurs near equilibrium conditions, so CALPHAD can be used to predict quantities defining the sintering window with high accuracy. Though the quantities defining the sintering window can be predicted by CALPHAD, the batch-to-batch variability in powder composition, though different batches are within specification, can deter defining an “optimal” sintering window for an alloy. One such example is for binder jetting of Inconel 718, where three different powder lots have different compositions, which lead to different sintering behavior. The problem associated with batch-to-batch variability can be overcome by conducting experiments for each batch or running thermodynamic calculations for each batch, both of which can prove expensive with regards to time and resources since there can be many alloy combinations, all of which are within specification.

Batch-to-batch variation in powder compositions for BJAM can significantly deter defining an “ideal” sintering window for a given alloy. One way to overcome the problem is by running sintering experiments at various temperatures for each batch of the powder. However, such an approach increases the time required to achieve large-scale production of parts. The predictive capabilities of computational thermodynamic techniques, such as CALPHAD, can be leveraged to overcome the challenge, especially for binder jet additive manufacturing, since the process occurs under near-equilibrium conditions. However, calculating the sintering window using CALPHAD can be computationally expensive, considering many possible feedstock compositions within “specification”. Certain examples solve these problems and technologically improve the BJAM process and associated additive manufacturing machine by generating high throughput CALPHAD data for nickel-based superalloys to develop machine learning models to predict the sintering window rapidly. The predictive capability of the models can be validated using published results on BJAM of Inconel 718 and 625, for example.

An example additive manufacturing process will now be described. Additive manufacturing processes fabricate components using three-dimensional (3D) information, for example, a three-dimensional computer model, of the component. Accordingly, a three-dimensional design model of the component may be defined prior to manufacturing. In this regard, a model or prototype of the component may be scanned to determine the three-dimensional information of the component. As another example, a model of the component may be constructed using a suitable computer aided design (CAD) program to define the three-dimensional design model of the component.

The design model may include 3D numeric coordinates of the entire configuration of the component including both external and internal surfaces of the component. For example, the design model may define the body, the surface, and/or internal passageways such as openings, support structures, etc. In one example, the three-dimensional design model is converted into a plurality of slices or segments, e.g., along a central (e.g., vertical) axis of the component or any other suitable axis. Each slice may define a thin cross section of the component for a predetermined height of the slice. The successive cross-sectional slices together form the 3D component. The component is then “built-up” slice-by-slice, or layer-by-layer, until finished.

As such, components can be fabricated using the additive process, or, more specifically, each layer is successively formed (e.g., by fusing or polymerizing a plastic using laser energy or heat or by sintering or melting metal powder). For example, a particular type of additive manufacturing process may use an energy beam, for example, an electron beam or electromagnetic radiation such as a laser beam, to sinter or melt a powder material. Any suitable laser and laser parameters may be used, including considerations with respect to power, laser beam spot size, and scanning velocity. The build material may be formed by any suitable powder or material selected for enhanced strength, durability, and useful life, particularly at high temperatures.

Each successive layer may be, for example, between about 10 micrometers (μm) and 200 μm, although the thickness may be selected based on any number of parameters and may be any suitable size according to alternative examples. Therefore, utilizing the additive formation methods described above, the components described herein may have cross sections as thin as one thickness of an associated powder layer, e.g., 10 μm, utilized during the additive formation process.

In addition, utilizing an additive process, the surface finish and features of the components may vary as needed depending on the application. For example, the surface finish may be adjusted (e.g., made smoother or rougher) by selecting appropriate laser scan parameters (e.g., laser power, scan speed, laser focal spot size, etc.) during the additive process, especially in the periphery of a cross-sectional layer which corresponds to the part surface. For example, a rougher finish may be achieved by increasing laser scan speed or decreasing the size of the melt pool formed, and a smoother finish may be achieved by decreasing laser scan speed or increasing the size of the melt pool formed. The scanning pattern and/or laser power can also be changed to change the surface finish in a selected area.

Notably, in examples described herein, several features of the components described herein were previously not possible due to processing and manufacturing constraints. However, the present inventors have developed improved BJAM processes and additive manufacturing machine configurations to improve component manufacture.

Unlike laser melting and laser sintering additive manufacturing techniques, which heat the material to consolidate and build layers of the material to form a printed part (e.g., metal or ceramic part), binder jetting uses a chemical binder to bond particles of the material into layers that form a green body of the printed part. As defined herein, the green body of the printed part is intended to denote a printed part that has not undergone heat treatment to remove the chemical binder. Chemical binding has been used in sand molding techniques to bond sand particles and form a sand mold that can be used to fabricate other parts. Similar to sand molding, in binder jet printing, the chemical binder is successively deposited into layers of powder to print the part. For example, the chemical binder (e.g., a polymeric adhesive) may be selectively deposited onto a powder bed in a pattern representative of a layer of the part being printed. Each printed layer may be cured (e.g., via heat, light, moisture, solvent evaporation, etc.) after printing to bond the particles of each layer together to form the green body part. After the green body part is fully formed, the chemical binder is removed during post-printing processes (e.g., de-binding and sintering) to form a consolidated part. In certain post printing processes, the green body part may undergo a de-powdering process. The de-powdering process removes portions of the powder that have not been bound (e.g., adhered) by the chemical binder. However, de-powdering of the green body part is generally done before heat treating (e.g., pre-sintering) the green body part. Heat treating the green body part removes the chemical binder and builds handling strength.

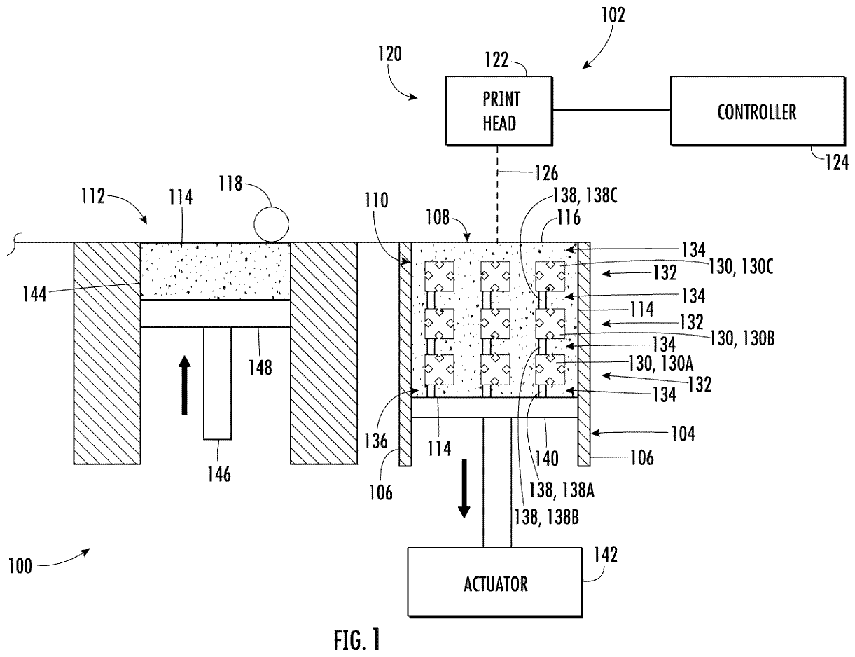

Referring now to the figures, the presently disclosed subject matter will now be described in further detail. FIG. 1 schematically depicts an example additive manufacturing system 100 according to the present disclosure. The additive manufacturing system 100 may include one or more additive manufacturing machines 102. In the illustrated example of FIG. 1, the additive manufacturing machine 102 is a binder jet additive manufacturing machine 102. In the illustrated example, the additive manufacturing machine 102 includes a build box 104 defined by a plurality of sidewalls 106 and defining a build chamber 108 for an additive manufacturing build 110. The additive manufacturing machine 102 includes a powder source 112 configured to deposit one or more layers of a powder build material 114 onto a build surface 116 within the build box 104. For example, the powder source 112 includes a spreader or recoater 118 configured to be movable across the powder source 112 to spread one or more layers of the powder build material 114 onto the build surface 116.

In the illustrated example, the additive manufacturing machine 102 includes a print system 120 including at least one print head 122 movable across the build surface 116, and a controller 124 communicatively coupled to the print head 122. The print head 122 is configured to dispense a binder 126 to the one or more layers of the powder build material 114 (e.g., on the build surface 116). The controller 124 is configured to control the movement of the print head 122 and the delivery of the binder 126 in a defined two-dimensional pattern to form one or more three-dimensional parts or objects 130 on a layer-by-layer basis. As depicted in FIG. 1, the one or more objects 130 may be formed or delineated into one or more build layers 132 vertically stacked and nested with one or more foundation layers 134 disposed vertically adjacent or between the one or more build layers 132. The one or more build layers 132 include the one or more objects 130 suspended within the powder build material 114, and the one or more foundation layers 134 include the powder build material 114 being devoid of the one or more objects 130.

In the example of FIG. 1, the build box 104 also includes a build plate 140 defining a lower boundary of the build chamber 108. The build plate 140 is vertically movable within the build box 104 by an actuator 142. In operation, the actuator 142 lowers the build plate 140 incrementally as each layer of the powder build material 114 is distributed across the build surface 116.

In the illustrated example of FIG. 1, the powder source 112 includes a supply chamber 144 containing a supply of the powder build material 114. A piston 146 is actuatable to elevate a supply chamber plate 148 during operation of the additive manufacturing machine 102. As the supply chamber plate 148 is elevated, a portion of the powder build material 114 is forced out of the supply chamber 144, and the recoater 118 sequentially distributes thin layers of the powder build material 114 onto the build surface 116 above the build box 104.

As described above, binder jetting uses a chemical binder to bond particles of the powder build material 114 into layers that form a green body of the printed object 130. After printing, the object 130 may undergo a de-powdering process to remove portions of the powder build material 114 that have not been bound (e.g., adhered) by the chemical binder (e.g., generally surrounding the green body of the printed object 130). De-powdering (such as using compressed air, ionized air, glass beads, other media, etc.) of the green body of the printed object 130 is generally done before heat treating (e.g., pre-sintering) of the green body of the printed object 130. Heat treating the green body removes the chemical binder and builds handling strength.

In the illustrated example, the additive manufacturing build 110 includes a sacrificial support system 136 configured to stabilize or support the one or more objects 130 within the powder build material 114. For example, the sacrificial support system 136 includes one or more sacrificial supports 138. The one or more sacrificial supports 138 are formed during the printing process (e.g., bonded particles of the powder build material 114 extending one or more layers also in a green state) such that each sacrificial support 138 is connected to or supports at least one of the one or more objects 130 within the powder build material 114. For example, in the illustrated example of FIG. 1, a sacrificial support 138A extends from the build plate 140 to an object 130A, a sacrificial support 138B extends from the object 130A to an object 130B, and a sacrificial support 138C extends from the object 130B to an object 130C. In the illustrated example, the sacrificial supports 138 are generally located within the foundation layers 134 and extend vertically with respect to the one or more objects to stabilize or support the one or more objects 130 in a vertical direction. However, it should also be understood that the sacrificial support system 136 may additionally or alternatively include horizontally-oriented sacrificial supports 138 (e.g., extending between one or more of the objects 130 in a plane parallel to the build plate 140) or sacrificial supports 138 disposed at other orientations within the additive manufacturing build 110. The sacrificial supports 138 are generally formed having a cross-sectional area providing support to the one or more objects 130 within the powder build material 114 while also being easily removed or detached from the one or more objects 130 after the printing process. Thus, for example, the sacrificial supports 138 may generally have a small cross-sectional area as compared to the one or more objects 130 such that detachment of the sacrificial supports 138 from the one or more objects requires minimal effort, such as minor machining, cutting, or manual separation of the object 130 from the sacrificial support 138.

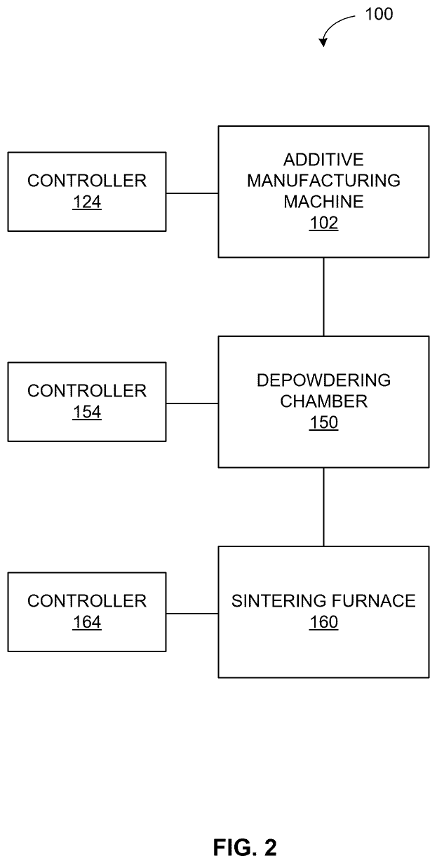

As shown in the example of FIG. 2, the build box 104 including the build plate 140 with the printed object 130 is loaded into a de-powdering chamber 150 to remove and collect unbound powder from the build box 104. For example, air, ionized air, inert gas, glass beads, and/or other media can be introduced in the de-powdering chamber 150 to remove unbound powder from the build box 104 in and around the printed object 130. After de-powdering, the build box 104 with build plate 140 is loaded into a sintering furnace and/or other sintering equipment 160. As shown in the example of FIG. 2, the additive manufacturing machine 102, the de-powdering chamber 150, and the sintering furnace 160 can each have their own associated controller 124, 154, 164 to configure and operate the respective device 102, 150, 160. In certain examples, the controllers 124, 154, 164 can be in communication to coordinate phases of the binder jet operation. In other examples, the controllers 124, 154, 164 can be implemented as a single controller connected to each device 102, 150, 160 to coordinate and control binder jet operation.

An example sintering process includes a plurality of phases: a temperature ramp up, a thermal de-binding or pre-sintering, a sintering, and a temperature cool down. During sintering, the green part 130 (a combination of metal powder and binder) is first heated to a temperature at which the binder evolves and is removed from the part 130. The sintering temperature of the metal is then ramped up or increased to a temperature just below the melting temperature of the material, fusing together the metal particles of the part 130. After sintering is complete, the printed part 130 includes little or no evidence of the original powder particles used to fabricate the part 130, which now has low porosity.

In certain examples, de-binding of the linkable thermoplastic binder used to form the object 130 can include heating the green body metal part 130 to a desired temperature (e.g., between approximately 250 °C and approximately 450 °C) in an oxygen-free environment (e.g., in a vacuum chamber or under inert atmosphere). For example, de-binding may be performed under nitrogen (N₂), argon (Ar), or another substantially inert gas. However, in certain examples, the de-binding may be performed in air. Due, in part, to the weak non-covalent forces linking the polymer strands of the linkable thermoplastic binder, de-binding in air may be done at temperatures less than approximately 450 °C, which blocks oxidation of the metal powder. As such, the overall properties of the consolidated metal part 130 printed using the linkable thermoplastic binder may be similar to the properties of the metal powder used to manufacture the 3D printed metal part 130.

Following de-binding of the linkable thermoplastic binder, the brown body metal part 130 is pre-sintered to remove the remaining portion of the linkable thermoplastic binder (e.g., oligomers formed during de-binding) in the brown body metal part 130. For example, as discussed above, the linkable thermoplastic binder may partially decompose to form oligomers that provide sufficient strength to the brown body metal part 130 formed from the green body metal part after partially de-binding the linkable thermoplastic binder. During pre-sintering, the brown body metal part 130 may be heated to pre-sintering temperatures that are between approximately 500 °C and approximately 800 °C. The heat applied to the brown body metal part during pre-sintering decomposes the remaining oligomers into small molecules that quickly volatilize and escape from the brown body metal part 130. The oligomers decompose cleanly into the smaller molecules, which may evaporate through the porous structure of the brown body, leaving substantially no residue. As such, when the brown body metal part 130 is subsequently sintered, the resulting consolidated metal part may be substantially free of char. Accordingly, the consolidated metal part 130 may have properties similar to those of the metal powder used to print the metal part 130.

The brown body metal part 130 is then sintered to consolidate the particles of metal powder without generating a metal oxides. During sintering, the brown body metal part 130 may be exposed to a concentrated source of energy (e.g., a laser, electron beam, or any other suitable energy source) that heats the brown body metal part 130 and consolidates the printed layers of the brown body to form a substantially solid metal part (e.g., the consolidated metal part) having a density that is greater than the density of the corresponding brown body metal part. Sintering imparts strength and integrity to the brown body metal part such that the consolidated metal part 130 is suitable for use in machinery. Sintering temperatures may be in excess of 1000 °C, depending on the metal powder used to print the part 130. For example, in certain embodiments, the sintering temperature may be between approximately 1200 °C and approximately 1400 °C. The part 130 can then be removed from the sintering furnace 160 and deployed for use.

In certain examples, in-depth thermo-kinetic calculations are conducted to determine the appropriate sintering temperatures and subsequent phase evolution. Such calculations can be extremely tedious and resource intensive and are conducted serially with one set of conditions at a time. As a result, it becomes extremely difficult to understand the combined effect of changes in multiple alloying elements and sintering time/temperature combinations on the resulting phase evolution of the part 130. The final phases directly impact material properties such as strength, hardness, and corrosion resistance.

As an example, in stainless steel 316, a high temperature delta phase can aid sintering. However, if the delta phase is retained at room temperature, it negatively impacts the corrosion resistance and fracture toughness of the steel. Formation and retention of delta phase is a complex function of powder alloy chemistry (even if the alloy is within the ASTM specifications), sintering time, temperature and cooling rate.

Currently, there is no available tool/method to capture these effects simultaneously that can aid in the selection of appropriate alloy chemistries and sintering windows. This limits the end user to manually vary one element at a time as well as very specific combination of time and temperature. However, in the real world, when an alloy is atomized to form powders, multiple elements in the alloy can vary depending on the atomization conditions, all within American Society for Testing and Materials (ASTM) specifications. Such subtle changes in alloy constituents can significantly impact the sintering conditions as well as the resulting material properties.

As described above, a sintering window refers to a period during which a combination of temperature and material heat capacity correlate to a desired density for the printed part. Currently, computational calculations for the sintering window are limited by the database availability and can be time-consuming in an industrial setting. For example, experimental sintering window determination is done using a trial-and-error approach for each feedstock composition, which is time and energy consuming. Further, having a large number of possible chemical composition combinations within ASTM specification limits exacerbates sintering window identification for a given lot of powder feedstock.

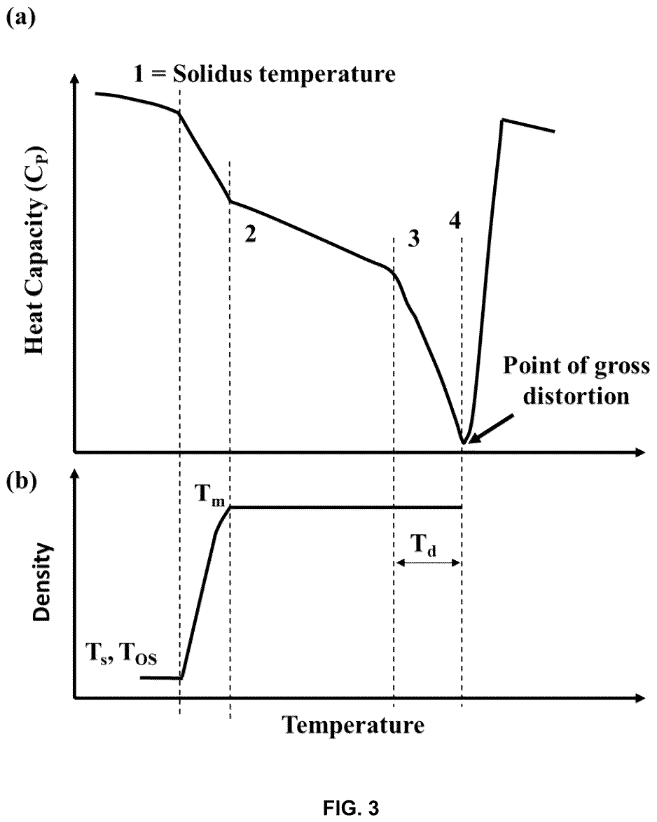

FIG. 3 shows an example sintering window defined in graph (a) by a heat capacity (Cp) as temperature (T) increases. Corresponding graph (b) shows density with respect to temperature. Correlating graphs (a) and (b) shows that, for a sinterable alloy, differential thermal analysis (DTA) thermograms expressed as a function of temperature can be divided into regions of solidus (Ts), onset of SLPS (Tos) (at point 1 in FIG. 3), a temperature at which maximum densification occurs (Tm) (at point 2 in FIG. 3), and a temperature at which distortion occurs (Td) (point 3 and point 4 in FIG. 3) with gross distortion occurring at point 4, which is the minimum the thermogram. The DTA thermograms can be re-written in terms of heat capacity as:

$${ΔT}_{DTA} {K}_{DTA} = ΔK ( {T}_{W} - {T}_{R} ) - ( {C}_{P , s} - {C}_{P , r} ) Φ - {C}_{P , s} \frac{d Δ {T}_{R}}{dt} + {Δ}_{t} H \frac{d ξ}{dt} . \qquad ( Equation 1 )$$

In Equation 1, ΔT_{DTA}K_{DTA}, is a measured DTA signal (temperature differential), Ts is a sintering temperature of a sample, T_{R} is a temperature of a reference sample, T_{W} is a temperature of the sintering furnace 160 wall, AK is a difference between coefficients of heat transfer between the furnace and sample holder and the furnace and reference holder;

$$Φ = \frac{d Δ {T}_{R}}{dt}$$

is an externally applied linear heating rate, K is an apparatus constant of a given DTA instrument, ΔtH is an integral enthalpy change due to phase transformations, and

$$\frac{d ξ}{dt}$$

is an extent of phase transformation. From Equation 1, neglecting the instrument constants, the DTA readings are directly proportional to the heat capacity (Cp). Both the critical volume fraction of liquid for distortion and Cₚ−T curves which indicate the distortion (minimum in the Cₚ−T curve) can be estimated using CALPHAD.

Unlike other fusion-based AM techniques, a binder jetting and sintering process occurs in near equilibrium conditions, such that CALPHAD can be used to predict quantities defining the sintering window with high accuracy. Though the quantities defining the sintering window can be predicted by CALPHAD, the batch-to-batch variability in powder composition (though different batches are within specification), can deter defining the “ideal” sintering window for an alloy. For example, binder jetting of Inconel 718 with three different powder lots will result in different compositions that have different sintering behavior. The problem associated with batch-to-batch variability can be overcome by conducting experiments for each batch or running thermodynamic calculations for each batch, both of which can prove expensive with regards to time and resources since there can be many alloy combinations all of which are within specification. To reduce and otherwise address the expenditure of time and resources, certain examples provide a coupled data analytics and CALPHAD approach to rapidly predict the sintering window while accounting for batch-to-batch variability given the composition of the alloy.

Certain examples bypass the extensive computational calculations and reduce the number of experiments for determining the sintering window. Certain examples provide a system and associated method to determine the sintering window for a particular material in a particular binder jet process. The system and associated method enable calculations on a large scale and enable optimization of sintering windows for an almost unlimited alloy combinations without the time and energy intensive trial and error method of having to sinter each new batch of powder to refine the sintering conditions and resulting phase evolution. The system and associated method serve as a tool to significantly reduce the cost and energy associated with developing sintering parameters for stainless steels and/or other materials.

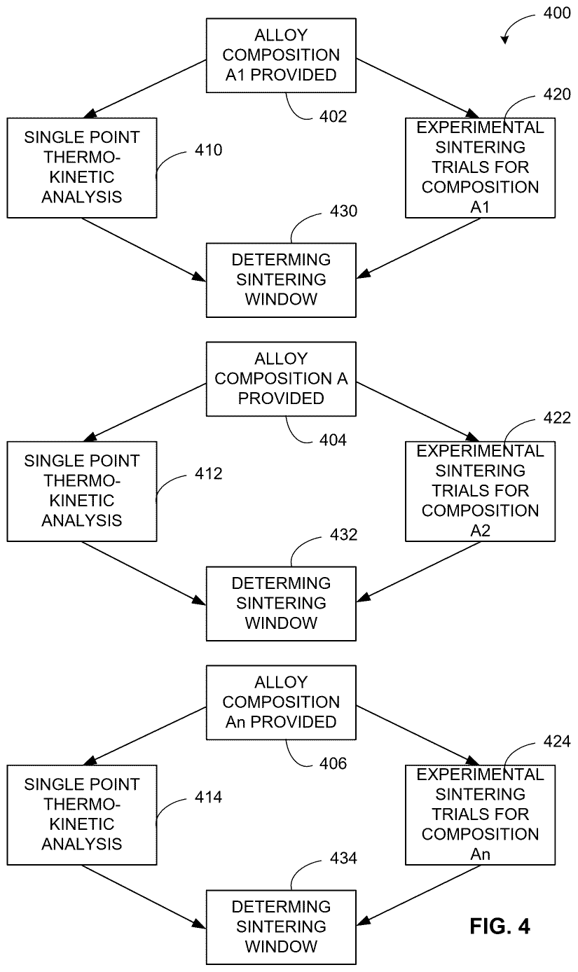

As illustrated in FIG. 4, a prior process 400 to determine the sintering window involves repeated determination for various alloy compositions. For example, at blocks 402, 404, 406, an alloy composition A₁, A₂, . . . Aₙ within ASTM specification is provided from a powder feedstock supplier. At blocks 410, 412, 414, a single point thermo-kinetic analysis is generated for the respective alloy composition. At blocks 420, 422, 424, experimental sintering trials are executed for composition A₁, A₂, . . . Aₙ. At blocks 430, 432, 434, results of the singe point thermo-kinetic analysis and the sintering trials are combined to determine the sintering window.

Certain examples bypass the extensive computational calculations and reduce experiments to determine the sintering window. Chemistry influences the phases present in a material being sintered. In stainless steel, the material has gamma, alpha and delta phases. Sintering is a diffusion based phenomenon, such that the faster the diffusion occurs, the quicker and better the sintering is. Traditionally, the sintering process can take hours, even days. In stainless steel, for example, delta ferrite is responsible for faster diffusion. At sintering temperature T_{S}, delta ferrite in stainless steel promotes quick sintering, faster within the limits of practicality (e.g., not holding material for days, done in hours). As such, targeting delta ferrite and/or other material in the delta phase can improve timing and quality of sintering.

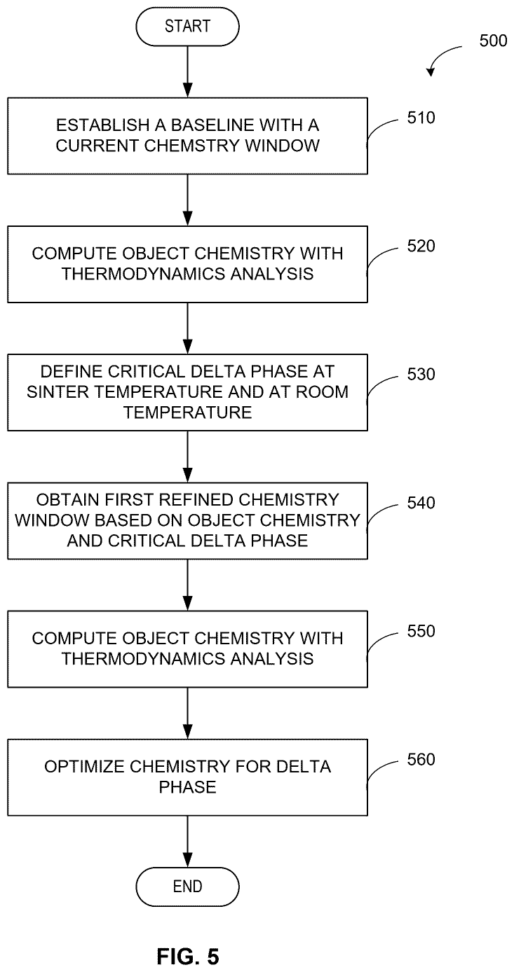

As shown in the example of FIG. 5, a window for sintering of stainless steel in the presence of delta ferrite is determined. For example, a maximum sintering temperature T_{S}_{ₘₐₓ} and a minimum sintering temperature T_{S}_{ₘᵢₙ}, can be determined to define a sintering window [T_{S}_{ₘᵢₙ}, T_{S}_{ₘₐₓ}]. At block 510, a baseline chemistry window is determined. The current chemistry window establishes a baseline for thermodynamic analysis to determine an optimized chemistry for a sintering material, such as delta ferrite, associated with the sintering window. At block 520, thermodynamic calculations are performed to compute object chemistry. For example, one or more thermodynamic databases (e.g., ThermoCalc™, Pandat™, etc.) are mined to extract delta phase stability at different temperatures and compositions.

At block 530, a “critical” or beneficial delta phase for sintering operation (e.g., delta ferrite sintering window) is defined between sintering temperature and room temperature. Then, at block 540, object chemistry computations are refined based on the determined object chemistry and delta phase. At block 550, thermodynamic calculations are again performed to compute object chemistry (e.g., as in block 520). At block 560, object chemistry is optimized for the delta phase (e.g., optimize chemistry for delta ferrite). Parameters can then be generated to configure and control sintering (e.g., with optimal delta ferrite).

The example process 500 of FIG. 5 can be leveraged to train and deploy an artificial intelligence model to determine a sintering window and associated parameters to configure operation of the sintering furnace 160. Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For example, the model may be trained with data to recognize patterns and/or associations and follow such patterns and/or associations when processing input data such that other input(s) result in output(s) consistent with the recognized patterns and/or associations.

In general, implementing an AI system involves two phases, a learning/training phase and an inferencing phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of AI model and/or the expected output. For example, supervised training uses inputs and corresponding expected (e.g., labeled) outputs to select parameters (e.g., by iterating over combinations of select parameters) for the AI model that reduce model error. As used herein, labelling refers to an expected output of the machine learning model (e.g., a classification, an expected output value, etc.) Alternatively, unsupervised training (e.g., used in deep learning, a subset of machine learning, etc.) involves inferring patterns from inputs to select parameters for the AI model (e.g., without the benefit of expected (e.g., labeled) outputs).

In examples disclosed herein, AI models are trained using stochastic gradient descent. However, any other training algorithm may additionally or alternatively be used. In examples disclosed herein, training is performed until an acceptable amount of error is achieved. Training is performed using hyperparameters that control how the learning is performed (e.g., a learning rate, a number of layers to be used in the machine learning model, etc.).

Training is performed using training data. In examples disclosed herein, the training data originates from publicly available data, locally generated data (e.g., previous builds). In certain examples, supervised training is used with training data labeled and/or otherwise identified by a user. Once training is complete, the model is deployed for use as an executable construct that processes an input and provides an output based on the network of nodes and connections defined in the model. The model is stored and can then be executed.

Once trained, the deployed model may be operated in an inference phase to process data. In the inference phase, data to be analyzed (e.g., live data) is input to the model, and the model executes to create an output. This inference phase can be thought of as the AI “thinking” to generate the output based on what it learned from the training (e.g., by executing the model to apply the learned patterns and/or associations to the live data). In some examples, input data undergoes pre-processing before being used as an input to the machine learning model. Moreover, in some examples, the output data may undergo post-processing after it is generated by the AI model to transform the output into a useful result (e.g., a display of data, an instruction to be executed by a machine, etc.).

In some examples, output of the deployed model may be captured and provided as feedback. By analyzing the feedback, an accuracy of the deployed model can be determined. If the feedback indicates that the accuracy of the deployed model is less than a threshold or other criterion, training of an updated model can be triggered using the feedback and an updated training data set, hyperparameters, etc., to generate an updated, deployed model.

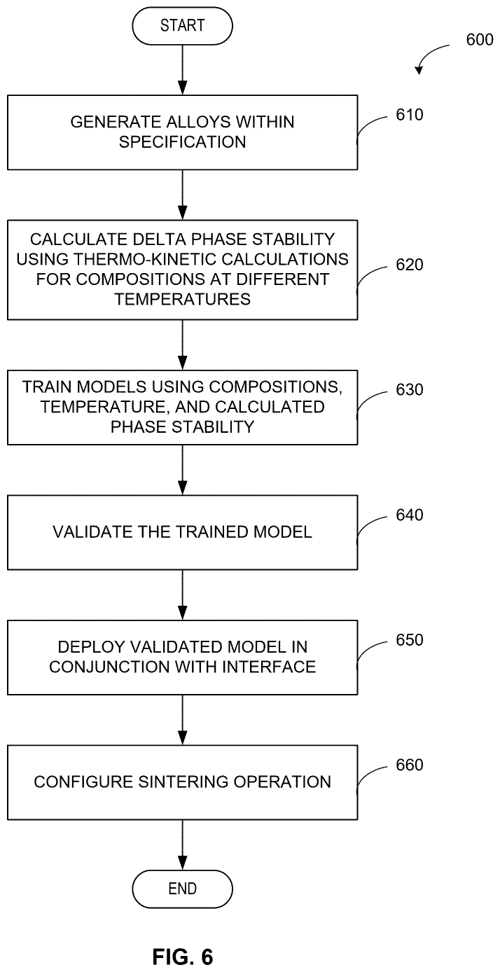

FIG. 6 depicts a flow diagram for an example process 600 to train and deploy an AI model, such as a regression model, etc., to determine a delta phase fraction associated with a sintering window and configure the additive manufacturing system 100 and its sintering furnace 160 according to that delta phase fraction and sintering window.

At block 610, a plurality of alloy compositions (e.g., steel compositions, etc.) are generated. For example, a plurality of stainless steel compositions are generated within ASTM specifications by simultaneous minute changes in each alloying element using a Gaussian distribution. Software tools such as Python™, etc., (with appropriate in-built libraries) can be used to generate the desired compositions. Random alloy compositions can be generated within the bounds of the specification to simulate batch-to-batch variation.

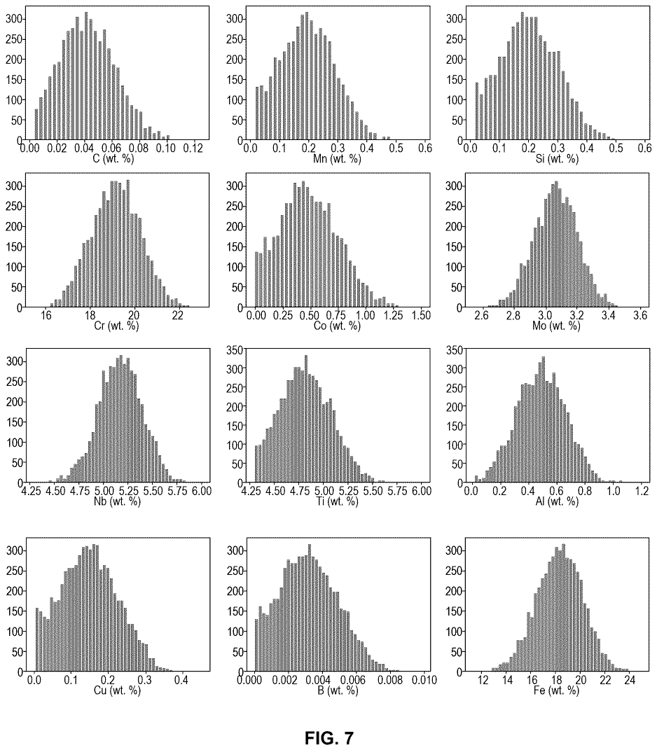

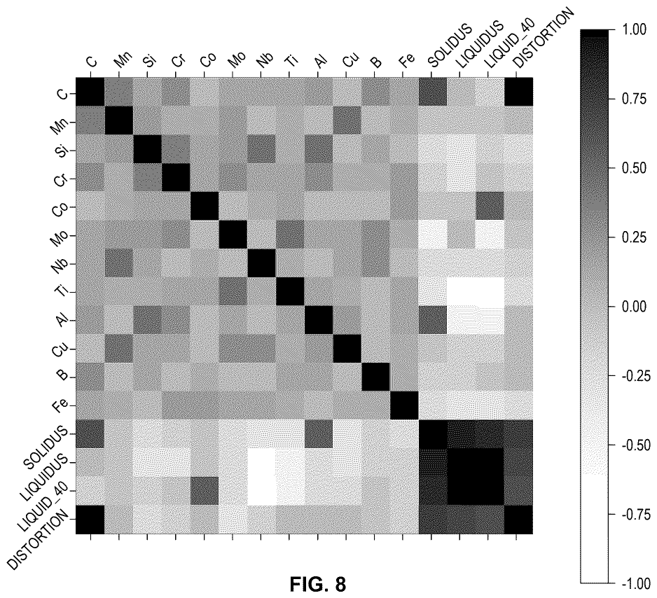

For example, FIG. 7 depicts a distribution of elemental composition for 5000 variations of an Inconel 718 alloy composition (e.g., using a database of TCNI11 nickel superalloys). FIG. 8 shows an example correlation matrix between composition of elements and solidus, liquidus, temperature to find 40% liquid, and distortion temperature. As shown in the example of FIG. 8, individual elements were varied in composition to follow a Gaussian distribution, with ends of the curve tailing off at maximum and minimum limit allowable as per ASTM standard, while possible combinations of variation in the alloy are controlled depending on a number of sample sets used for a property model calculation.

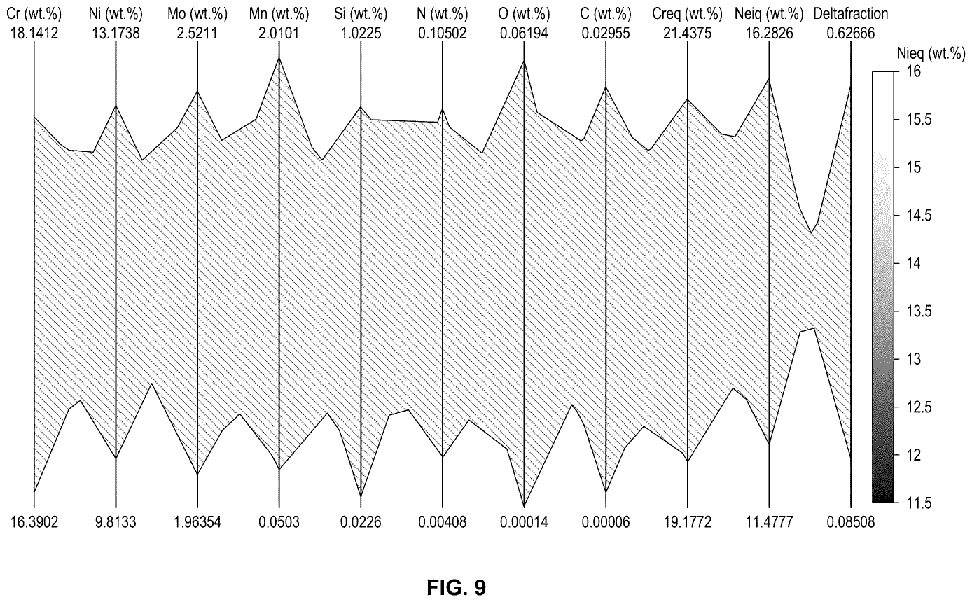

At block 620, delta phase stability is calculated using thermo-kinetic calculations for compositions at different temperatures. For example, a thermodynamic database (e.g., ThermoCalc™, Pandat™, etc.) is used for thermos-kinetic calculations to extract the delta phase stability at different temperatures and compositions that were generated at block 610. Temperature values such as solidus temperature, liquidus temperature, temperature at 40% liquid volume, and temperature corresponding to a minimum of a Cp versus T curve can be determined and used to calculate delta phase stability associated with a sintering window, for example. FIG. 9 illustrates an example graph of delta phase stability at different temperatures for different compositions.

At block 630, the calculated delta phase stability, temperature, and composition are used to train one or more AI models (e.g., non-linear regression model, etc.). For example, delta phase stability and temperature for a given alloy composition are used to train the model, and a plurality of such combinations are applied to train behavior of the model to identify a sintering window and associated sintering process parameters. In certain examples, 60% of data is used for training, and 30% of the data is reserved for testing. The remaining 10% can be used for validation, discarded, etc. In certain examples, four types of AI regression models are trained: random forest, XGBoost, neural network, and gradient boosting AI models.

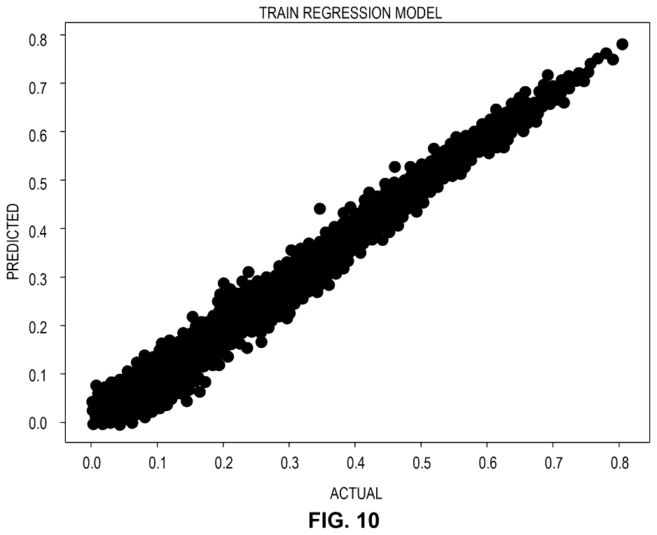

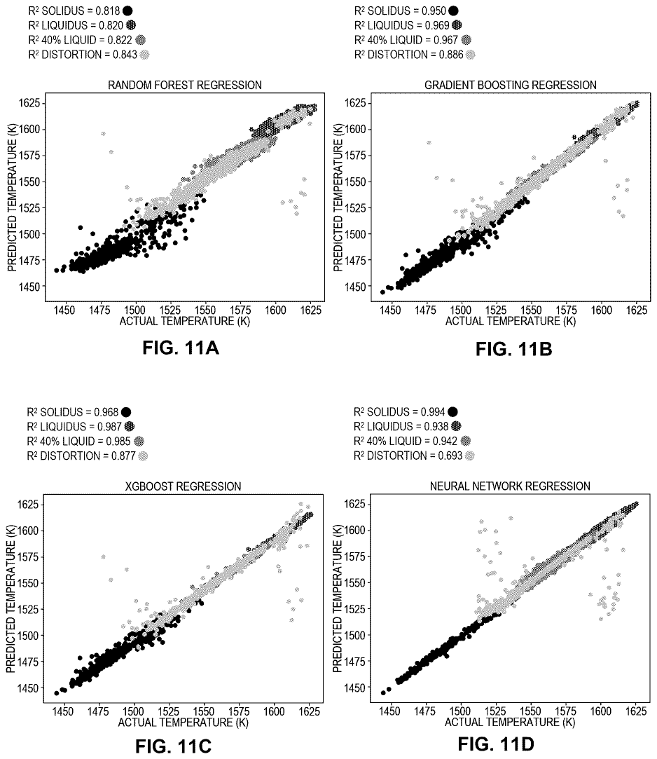

FIG. 10 is a graph showing an example distribution of data points used in training a regression model. FIGS. 11a-11d show additional regression training examples for a variety of models including a random forest regression model (FIG. 11a), a gradient boosting regression model (FIG. 11b), an XGBoost regression model (FIG. 11c), and a neural network regression model (FIG. 11d). FIGS. 10-11d show example results of regression model-predicted solidus, liquidus, 40% liquid, distortion temperatures estimated temperatures for the testing data, and corresponding cross-validation score (R2) values for the different example machine learning models.

At block 640, the trained AI model(s) are validated. For example, blocks 610 and 620 can be repeated and applied to validate the trained AI model based on a data fit at block 640 (e.g., using a remaining 10% of data generated previously for training and testing, etc.). As another example, further experimentation can generate data to be applied to the AI model to validate the trained AI model, and/or publicly available data set(s) can be applied to validate the trained AI model (e.g., the trained regression model, etc.). The validated AI model (e.g., a validated regression model, etc.) can be used to predict the sintering window for any powder composition, for example.

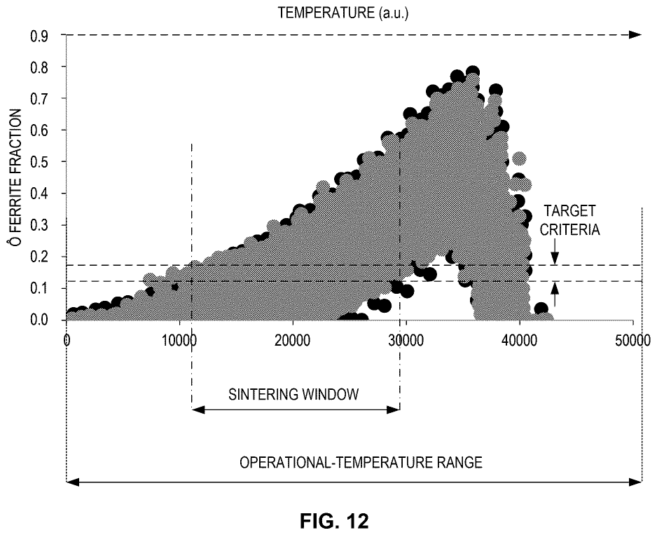

FIG. 12 is an example graph showing regression model validation. As shown in the example of FIG. 12, an operational temperature range of 0 to 50000 is evaluated, and a sintering window is determined, along with a target critical delta (δ) ferrite fraction range. As illustrated in the example of FIG. 12, N discrete temperatures Tⱼ of operational-temperature range [Tₒₚ_{ₘᵢₙ}, Tₒₚ_{ₘₐₓ}] are separated by an interval

$$ΔT = \frac{{T}_{{op}_{max}} - {T}_{{op}_{min}}}{N} ,$$

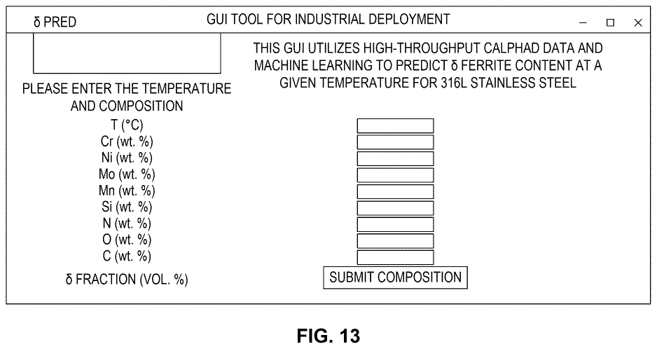

such that Tⱼ=Tⱼ₊₁+ΔT. N can be selected such that ΔT is a fraction 1% to 20% of (Tₒₚ_{ₘₐₓ}−Tₒₚ_{ₘᵢₙ}). At block 650, the validated model is deployed. For example, the one or more validated, trained AI models are deployed with a graphical user interface tool. The tool can be used to receive input such as composition, sintering process variables, etc., which are provided to the deployed AI model to estimate a delta phase fraction. Alternatively or additionally, the input (e.g., composition, sintering process variables, etc.) can be read from a database, configuration file, etc., rather than provided via the tool. FIG. 13 illustrates an example graphical user interface tool that takes an input of composition and temperature to generate a prediction of delta ferrite content at a given temperature for 316L stainless steel using a deployed AI regression model.

At block 660, a sintering process is configured. For example, the controller 164 configures the sintering furnace 160 based on the composition, delta phase fraction, and other sintering process parameters according to the determined sintering window. In certain examples, a binder jet process can be aborted, adjusted, flagged, etc., if it is determined that the material to be printed does not satisfy the parameters for the sintering window.

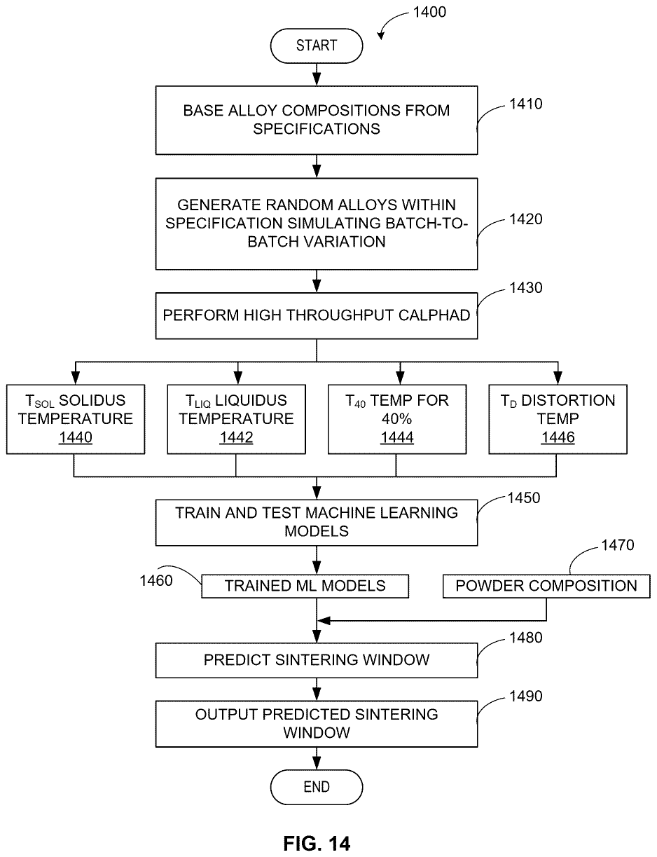

FIG. 14 illustrates an example implementation of the process 600 for a plurality of temperatures. At block 1410, a plurality of base alloy compositions are generated (e.g., M material compositions) within the bounds of the specification using thermos-kinetic analysis. For example, a large number (e.g., 1000, 5000, 10,000, etc.) of hypothetical Inconel 718 alloy compositions within the ASTM specifications are generated using thermo-kinetic property analysis using TNC111 nickel superalloy data. Individual elements can be varied in composition to follow a Gaussian distribution such as shown in FIG. 7, with ends of the curve tailing off at maximum and minimum limit allowable as per ASTM standard, while possible combinations of variation in the alloy can be controlled depending on the number of sample sets for the property model calculation. In this example, 5000 possible alloy combinations are generated. In other examples, another number, such as 1000 to 10,000, etc., of possible alloy combinations can be generated.

Once different alloy combinations are generated, at block 1420, equilibrium phase evolution with variation in temperature is conducted for the alloys to generate random variations (e.g., using the TC-Python interface of ThermoCalc). Thermodynamic calculations for each of the compositions (e.g., 1000, 5000, 10,000 compositions, etc.) are solved sequentially to extract the volume fraction of liquid, solidus temperature, liquidus temperature, and temperature at which the alloys form 40% liquid, denoted as Liquid-40. Molar enthalpy change as a function of temperature is also extracted to calculate the variation in Cₚ values for each alloy with temperature. The Cₚ values were used to determine the temperature at which significant distortion occurs as outlined in literature. FIG. 8, for example, shows the correlation matrix of each element to the outputs. Chromium (Cr), Niobium (Nb), and Boron (B) have a strong negative correlation on the solidus temperature of the alloys, whereas Carbon (C) has a slight positive correlation with respect to the solidus temperature. While several elements have a negative correlation with liquidus temperature, Titanium (Ti) has the strongest negative correlation with respect to the liquidus and temperature to form 40% liquid. With respect to the distortion temperature, C has a strong positive correlation with the distortion temperature.

At block 1430, high throughput CALPHAD analysis is performed to generate data containing composition of a plurality elements (e.g., 10, 12, 14, etc.) as the input, and the solidus temperature (T_{SOL}) 1440, liquidus temperature (T_{LIQ}) 1442, temperature to form 40% liquid (T₄₀) 1444, and distortion temperature (TD) 1446. At block 1450, the output temperatures 1440-1446 are used to train AI models. For example, four decision tree-based multi-output machine learning regression models (e.g., (i) a random forest regression, (ii) a gradient boosting regression, (iii) an XGBoost regression, and (iv) a neural network regression) are trained. Among the data for 5000 compositions, for example 3000 compositions can be used to train the machine learning models, and the remaining 2000 compositions can be used to test the machine learning models.

In certain examples, machine learning models are implemented in Python™, and associated hyperparameters for each model are tuned using a randomized search cross-validation algorithm. In certain examples, for the random forest regression, gradient boosting regression, and XGBoost regression models, a number of estimators is varied from 10 to 2000 with an interval of 10; maximum depth is varied from 0 to 120 with an interval of 1; minimum samples split is varied from 2 to 10 with an interval of 1; minimum samples leaf is varied from 1-5 with an interval of 1; and learning rate is varied from 0 to 0.3 with an interval of 0.001. For the neural network regression, a number of hidden layers is varied from 2 to 5; a number of neurons per hidden layer is varied from 10 to 200 with an interval of 10; a learning rate is varied from 0 to 0.3 with an interval of 0.001; a number of epochs is varied from 100 to 3000 with an interval of 100; and batch size is varied from 1 to 200. Functions such as relu, sigmoid, softplus, softsign, tanh, selu, elu activation functions can be considered when tuning the hyperparameters for neural network regression. To minimize the error for prediction, dropout regularization can be used with the dropout values varying from 0 to 1 with an interval of 0.1, for example. Example tuned hyperparameters for different machine learning models are shown in Table 1.

TABLE 1

| Random forest regression | | Gradient boosting regression | |
|---|---|---|---|
| No. of estimators | 1560 | No. of estimators | 1560 |
| Minimum samples split | 2 | Minimum samples split | 10 |
| Minimum samples leaf | 2 | Minimum samples leaf | 2 |
| Maximum features | Auto | Maximum features | auto |
| Maximum depth | 9 | Maximum depth | 5 |
| Criterion | Mean squared error | Estimator criterion | Mean squared error |
| Bootstrap | TRUE | Estimator learning rate | 0.05 |
| | | Batch size Activation function | 67 relu |
| XGBoost regression | | No. of hidden layers | |
| Booster | gbtree | | 3 |
| Bootstrap | TRUE | No. of neurons | 160 |
| Learning rate | 0.1 | Learning rate | 0.01 |
| Max depth | 3 | Epochs | 2900 |
| No. of estimators | 1930 | Dropout | 0 |
| | | Batch size Activation function | 67 relu |

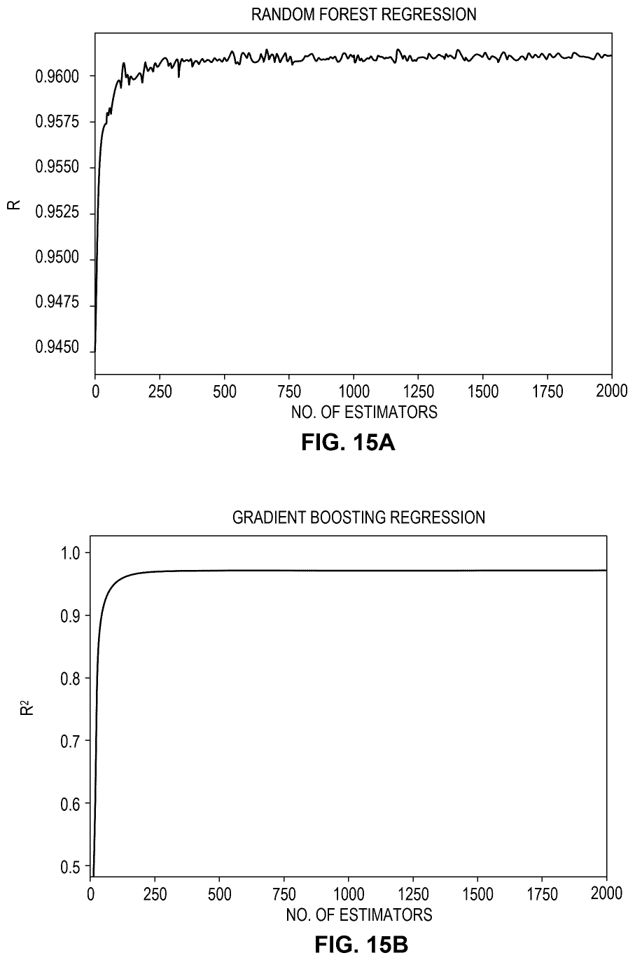

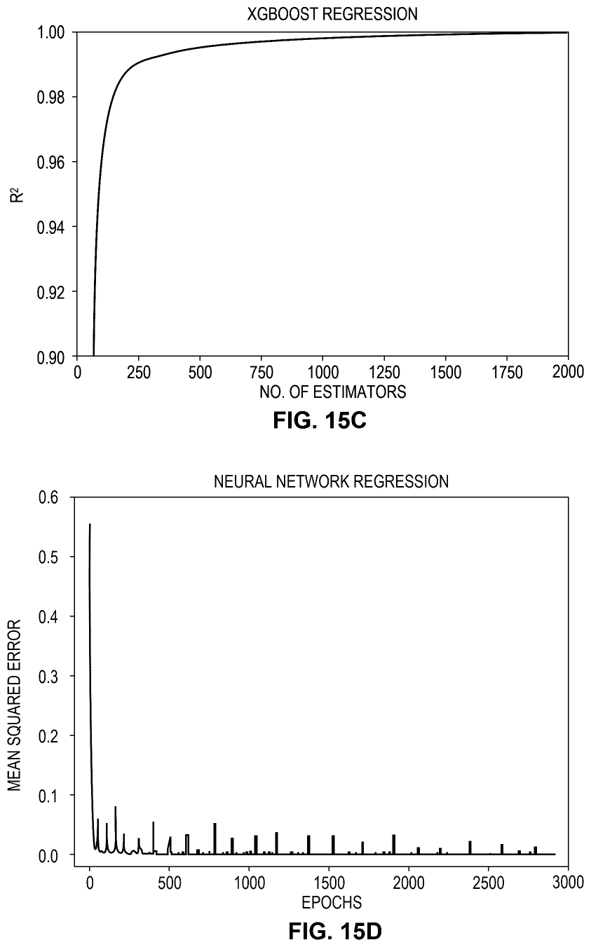

FIGS. 15a-d show example variations in cross-validation score (R2 for random forest regression, gradient boosting regression, XGBoost regression, and mean squared error for neural network regression) with the number of estimators and epochs for the different machine learning models. FIGS. 15a-d depict results of hyper-parameter tuning for different machine learning models employed. It can be seen that the cross-validation score (e.g., R2) increases with the increase in number of estimators for the random forest, gradient boosting, and XGBoost regression models and stabilizes at the optimum value. For the neural network regression, the cross-validation score (e.g., the mean squared error) reduces with the increase in epochs. It can be seen that at lower epochs, a fluctuation in cross-validation score is observed, but the fluctuations stabilize at the optimum value of epochs.

FIG. 11 shows the testing of the different machine learning models along with the R2 cross-validation score. It can be seen that the machine learning models have a higher cross-validation score indicating the predictive accuracy of the models. Among machine learning models used in the examples shown, neural network and XGBoost regression resulted in the best cross-validation score for the 4 outputs (solidus, liquidus, temperature to form 40% liquid, and distortion temperature). Using the trained models, published data on binder jet additive manufacturing and sintering of Inconel 718 and 625 can be used to predict the sintering window. Table 2 shows example composition of different alloys with reported distortion temperature, which are used to predict the sintering window.

TABLE 2

| Alloy | C | Mn | Si | Cr | Co | Mo | Nb | Ti | Al | Cu | B | Fe |
|---|---|---|---|---|---|---|---|---|---|---|---|---|
| Alloy1 | 0.05 | 0 | 0 | 19.11 | 0.09 | 3.13 | 5.07 | 0.94 | 0.43 | 0 | 0 | 17.92 |
| Alloy2 | 0.0565 | 0.06 | 0.21 | 19.1 | 0.004 | 3.1 | 4.6 | 0.88 | 0.43 | 0.07 | 0.004 | 16.4 |
| Alloy3 | 0.0452 | 0.006 | 0.02 | 17.3 | 0.004 | 2.9 | 4.7 | 0.99 | 0.51 | 0.05 | 0.002 | 17 |
| Alloy4 | 0.046 | 0.009 | 0.02 | 17.5 | 0.004 | 3 | 4.8 | 1 | 0.5 | 0.05 | 0.002 | 16.8 |
| Alloy5 | 0.043 | 0.12 | 0.28 | 18.8 | 0 | 3.2 | 5.3 | 0.93 | 0.49 | 0 | 0.004 | 18.233 |
| Alloy6 | 0.08 | 0.12 | 0.28 | 18.8 | 0 | 3.2 | 5.3 | 0.93 | 0.49 | 0.3 | 0.006 | 17.894 |
| Alloy7 | 0.055 | 0.02 | 0.035 | 19 | 0.18 | 3.06 | 5.12 | 0.92 | 0.58 | 0.049 | 0.0005 | 17.98 |
| Alloy8 | 0.024 | 0.13 | 0.014 | 17.57 | 0.0089 | 3.04 | 5.01 | 0.094 | 0.59 | 0.043 | 0.0005 | 18.06 |
| Alloy9 | 0.045 | 0.087 | 0.21 | 18.16 | 0.13 | 3.01 | 4.95 | 0.94 | 0.46 | 0.14 | 0.0005 | 20.3 |
| Alloy10 | 0.6 | 0 | 0 | 23 | 12 | 9 | 0 | 0.4 | 1.1 | 0 | 0.001 | 1.5 |
| Alloy11 | 0.09 | 0.8 | 0.7 | 16.9 | 0.62 | 8.7 | 3.7 | 0.16 | 0.05 | 0 | 0 | 3.7 |
| Alloy12 | 0.09 | 0.4 | 0 | 21.8 | 0.62 | 9.3 | 3.5 | 0.16 | 0.05 | 0 | 0 | 3.6 |
| Alloy13 | 0.01 | 0.4 | 0.5 | 21.8 | 0.22 | 8 | 3.6 | 0.02 | 0.02 | 0 | 0 | 4.4 |
| Alloy14 | 0.01 | 0.4 | 0.4 | 21.5 | 0 | 8.9 | 3.3 | 0 | 0 | 0 | 0 | 4.2 |
| Alloy15 | 0.043 | 0.12 | 0.28 | 18.8 | 0 | 3.2 | 5.3 | 0.93 | 0.49 | 0 | 0.004 | 18.533 |
| Alloy16 | 0.14 | 0.2 | 0.13 | 21.01 | 0.21 | 8.46 | 3.99 | 0.2 | 0.04 | 0 | 0 | 2.67 |
| Alloy17 | 0.03 | 0.2 | 0.13 | 21.2 | 0.21 | 8.91 | 3.63 | 0.01 | 0.05 | 0 | 0 | 3.09 |

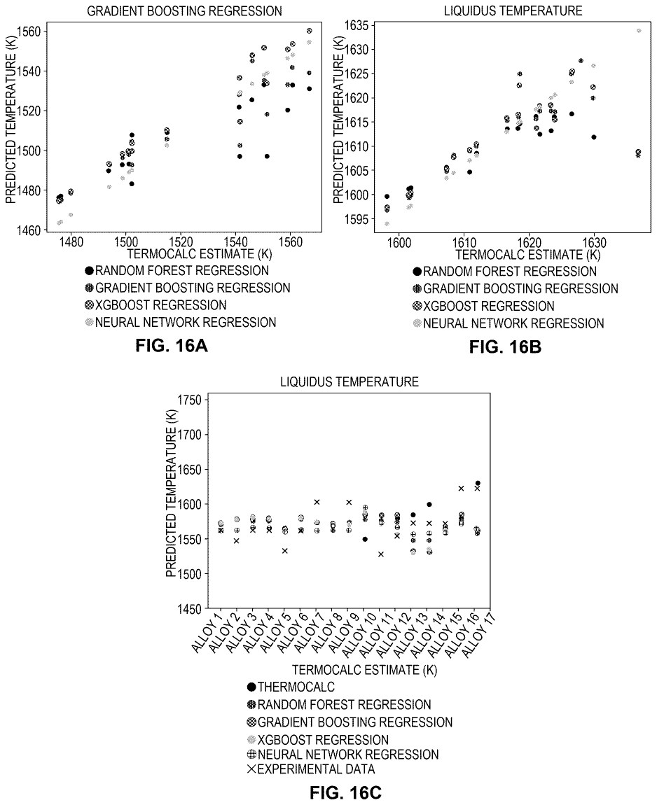

FIGS. 16a-b compare predicted values from the regression models and estimated solidus/liquidus temperature values from thermo-kinetic analysis for the alloys. FIG. 16a shows a comparison of predicted temperature values from the regression models and the estimated solidus temperature. FIG. 16b comparison of predicted temperature values from the regression models and the estimated liquidus temperature. FIG. 16c represents experimentally reported distortion temperatures with the regression model predicted distortion temperature for a variety of alloys. In FIG. 16c, alloys 1-9 represent Inconel 718 compositions and alloys 10-17 represent Inconel 625 compositions.

FIGS. 16a-b show that the models predict the solidus and liquidus temperature reasonably well. Maximum absolute error in solidus predictions of the examples is 3.5%, 2.5%, 1.7%, and 0.8%, and the liquidus temperature is 1.72%, 1.76%, 1.72%, and 0.20% for the random forest regression, gradient boosting regression, XGBoost regression, and neural network regression, respectively. The example maximum absolute error in solidus and liquidus is for predictions on Inconel 625 composition. In these examples, the maximum absolute error for just the Inconel 718 composition for the solidus were 1.31%, 0.85%, 0.30%, and 0.6%, and the liquidus temperature were 0.60%, 0.12%, 0.07%, and 0.08% for the random forest regression, gradient boosting regression, XGBoost regression, and neural network regression, respectively, indicating that the trained models have a higher prediction accuracy for Inconel 718 composition. FIG. 16c compares predicted distortion temperature values from the regression models with temperature values of experimentally reported distortion temperature. As shown in FIG. 16c, the models predict the distortion temperature reasonably well. The maximum absolute error in the predicted distortion temperature is 4.18%, 3.86%, 3.72%, 3.75% for the random forest regression, gradient boosting regression, XGBoost regression, and neural network regression, respectively. Similar to the solidus and liquidus temperature, the Inconel 625 alloy composition has the highest maximum absolute error for the distortion temperature predictions. The maximum absolute error in distortion temperature for just the Inconel 718 compositions is 2.1%, 2.0%, 2.0%, and 2.5% for the random forest regression, gradient boosting regression, XGBoost regression, and neural network regression, respectively, indicating a superior predictive capability of the models for Inconel 718 compositions.

At block 1460, one or more trained AI models (e.g., trained machine learning (ML) models are deployed for use. The model(s) inference on powder composition information 1470 to predict, at block 1480, a sintering window [T_{S}_{ₘᵢₙ}, T_{S}_{ₘₐₓ}]. At block 1490, the predicted sintering window is output to the controller 164 to configure and control operation of the sintering furnace 160, for example. For example, operation of the sintering furnace can be timed to the predicted sintering window to sinter the printed part 130. Using the predicted sintering window, operation of the sintering furnace 160 can be improved to provide consistent density in the part 130 after sintering. Such consistent density is not possible with the tradition window of chemistry.

For example, the trained AI model(s) can be used to predict a set of temperatures {T_{SOL}, T_{40%}, T_{D}, T_{LIQ}} for an alloy composition and instruct the sintering furnace 160 to sinter the part 130, made from the alloy composition, at a sintering temperature T_{S} that is greater than the predicted solidus temperature T_{SOL}_{ₑ} and less than the smaller of the predicted 40% liquid-volume fraction temperature T_{40%}_{ₑ} or the predicted distortion temperature T_{D}_{ₑ}. A corrective action can be triggered when a predicted sintering temperature Tₛ_{ₑ} is outside a sintering window [T_{S}_{ₘᵢₙ}, T_{S}_{ₘₐₓ}].

In certain examples, a build can be canceled or scrapped based on an incompatibility between operating conditions of the current build and the predicted sintering window. In certain examples, the build can be adjusted based on the predicted sintering window. In certain examples, an alert or flag can be triggered to prompt adjustment of the build based on the predicted sintering window. As such, a corrective action (e.g., adjustment of build parameters, canceling of a build, alerting an external actor, etc.) can be triggered if an incompatibility between the predicted sintering window and the build parameters is identified.

As such, the example processes 500, 600, 1400 are geometry-agnostic, improving the sintering process and quality of the printed part based on an identification of the powder used and a target density. For example, the sintering window for a stainless steel powder at a minimum target density of 98% can be determined using a trained ML regression model.

In certain examples, the example process 1400 can be used to generate a predicted amount of delta ferrite to be used for sintering at a certain temperature. The predicted amount can evaluate the amount in comparison to a parameter or other input indicative of an amount of delta ferrite in the composition being processed. If the actual amount of delta ferrite is less than the amount of delta ferrite required/estimated/predicted for sintering, then the scheduled print can be flagged or disabled for correction so that parameters, material, etc., can be adjusted before an erroneous print is generated and wasted, for example.

For example, a trained AI model can be used to predict a delta phase stability, such as a delta ferrite fraction. For a plurality of material compositions, such as a plurality of stainless steel compositions, thermo-kinetic calculations that simulate sintering for each of N sintering-temperature values can be used to determine a critical delta ferrite fraction f_{δ}_{_{i,j}} corresponding to each of M generated stainless steel compositions, where i=1 . . . M, j=1 . . . N. The trained AI model can be used to predict a critical delta ferrite fraction f_{δ}_{_{i,j}} of the stainless steel with a first stainless steel composition when sintered at a sintering temperature T_{S}_{_{new}}. A target critical delta ferrite fraction range [f_{δ}_{ₘᵢₙ},f_{δ}_{ₘₐₓ}] is determined, and the sintering furnace 160 is instructed to sinter the part 130, made from stainless steel feedstock powder with the first stainless steel composition, at the sintering temperature T_{S}_{_{new}}, when the predicted critical delta ferrite fraction f_{δ}_{ₑ} is within a target critical delta ferrite fraction range [f_{δ}_{ₘᵢₙ},f_{δ}_{ₘₐₓ}]. When the predicted critical delta ferrite fraction f_{δ}_{ₑ} is outside the target critical delta ferrite fraction range [f_{δ}_{ₘᵢₙ},f_{δ}_{ₘₐₓ}]., then a corrective action is performed, such as canceling the build, adjusting material, adjusting temperature, etc.

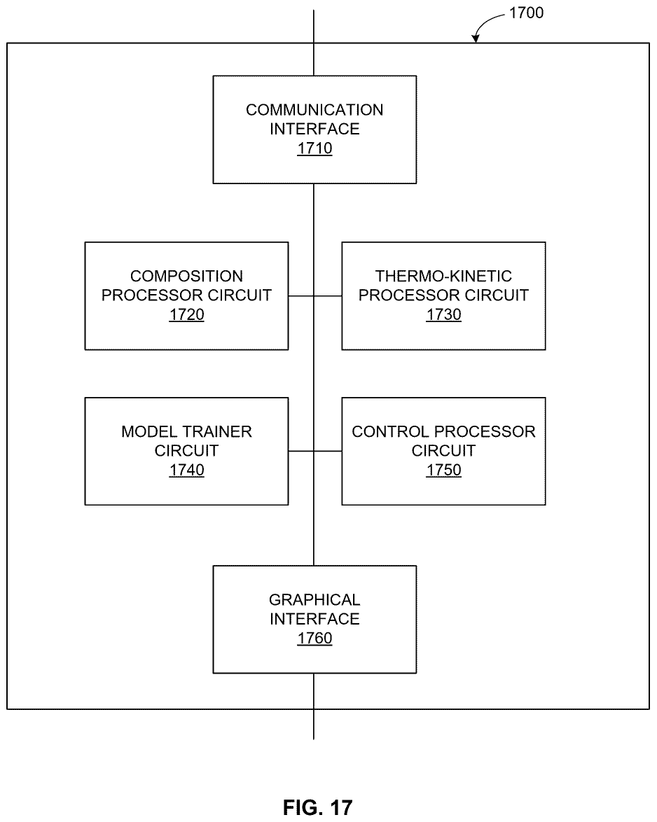

FIG. 17 is an example sintering control system or circuit 1700, which can be used to implement at least a portion of the example controller 164, the example controller 124, and/or a separate computing device, such as on an analytics computer connected to the additive manufacturing system 100. The example system 1700 includes a communication interface 1710, a composition processor circuit 1720, a thermo-kinetic processor circuit 1730, a model trainer circuit 1740, a control processor circuit 1750, and a graphical interface 1760. The circuits 1720-1750 of the sintering control system 1700 execute the processes 500, 600, 1400 described above.

For example, the composition processor circuit 1720 processes an input alloy composition and generates variations of the alloy composition, additional alloy compositions, etc. The example thermo-kinetic processor circuit 1730 performs thermo-kinetic calculations on an output of the composition processor circuit 1720 to determine delta phase stability for compositions at different temperatures. For example, thermo-kinetic analysis can determine a stability or extent of change in density at a set temperature. A plurality of thermo-kinetic calculations, each at a different temperature, provides a quantification of the stability of the composition in the delta phase. A sintering window for the composition can then be determined from the thermo-kinetic quantification.

The example model trainer circuit 1740 takes composition, temperature, and calculated phase stability from the composition processor circuit 1720 and the thermo-kinetic processor circuit 1730 to train, test, and validate one or more AI models (e.g., one or more machine learning regression models, etc.). A validated model (or set of models) ais deployed for use by the control processor circuit 1750 to control sintering operation of the additive manufacturing system 100.

In certain examples, settings, status, etc., can be displayed via the graphical interface 1760. The graphical interface 1760 can also accept input to generate sintering parameters based on input composition. The example communication interface 1710 can be a wired and/or wireless interface to communicate with the sintering furnace 160 and/or other controller 124, 154, 164, and/or other component of the additive manufacturing system 100.

In certain examples, a deployed model and/or the thermo-kinetic processor circuit 1730 can be used to generate a predicted amount of delta ferrite to be used for sintering at a certain temperature. The control processor circuit 1750 can evaluate the amount in comparison to a parameter or other input indicative of an amount of delta ferrite in the composition being processed. If the actual amount of delta ferrite is less than the amount of delta ferrite required/estimated/predicted for sintering, then the control processor circuit 1750 can flag or disable printing at the controller 124 so that parameters, material, etc., can be adjusted before an erroneous print is generated and wasted.

While example implementations of the additive manufacturing system 100, the additive manufacturing machine 102, the controller 124, the controller 154, the controller 164, and the sintering control system 1700 are illustrated in FIGS. 1, 2, and 17, one or more of the elements, processes and/or devices may be combined, divided, re-arranged, omitted, eliminated and/or implemented in any other way. Further, one or more of the elements of FIGS. 1, 2, and 17 may be implemented by hardware, software, firmware and/or any combination of hardware, software, and/or firmware. Thus, for example, any of the example elements of FIGS. 1, 2, and 17 can be implemented by one or more analog or digital circuit(s), logic circuits, programmable processor(s), programmable controller(s), graphics processing unit(s) (GPU(s)), video processing unit(s) (VPU(s)), accelerator card(s), digital signal processor(s) (DSP(s)), application specific integrated circuit(s) (ASIC(s)), programmable logic device(s) (PLD(s)), TPM(s), FPGA(s), and/or field programmable logic device(s) (FPLD(s)). When reading any of the apparatus or system claims of this patent to cover a purely software and/or firmware implementation, at least one of the example elements of FIGS. 1, 2, and 17 is/are hereby expressly defined to include a non-transitory computer readable storage device or storage disk such as a memory, a digital versatile disk (DVD), a compact disk (CD), a Blu-ray disk, etc., including the software and/or firmware. Further still, the elements of FIGS. may include one or more elements, processes and/or devices in addition to, or instead of, those illustrated in FIGS. 1, 2, and 17, and/or may include more than one of any or all of the illustrated elements, processes, and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

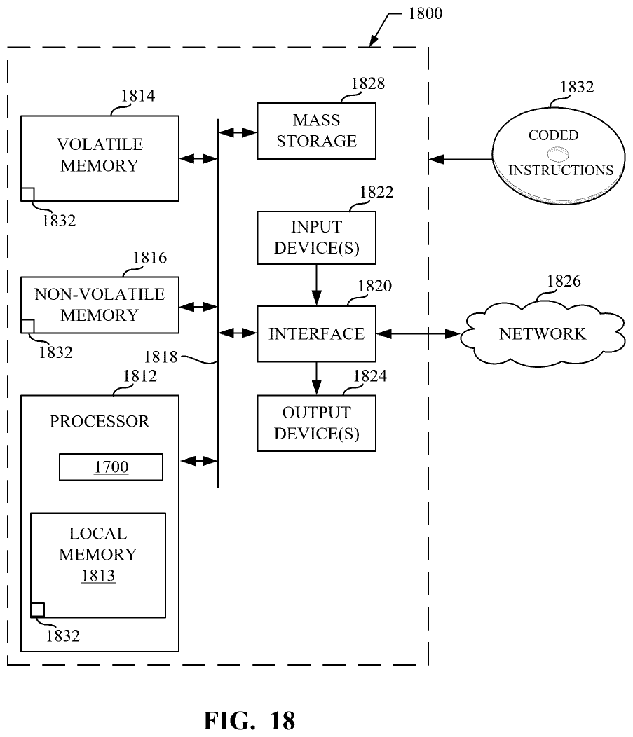

Flowcharts representative of example hardware logic, machine readable instructions, hardware implemented state machines, and/or any combination thereof for implementing the example sintering control system 1700 are shown in FIGS. 5, 6, and 14. The machine readable instructions may be one or more executable programs or portion(s) of an executable program for execution by a computer processor and/or processor circuitry, such as the example sintering control system 1700 and/or the example processor platform 1800 discussed below in connection with FIG. 18. The program may be embodied in software stored on a non-transitory computer readable storage medium such as a CD-ROM, a floppy disk, a hard drive, a DVD, a Blu-ray disk, or a memory associated with the processor 1812, but the entire program and/or parts thereof could alternatively be executed by a device other than the processor 1812 and/or embodied in firmware or dedicated hardware. Further, although the example program is described with reference to the flowcharts illustrated in FIGS. 5, 6, and 14, many other methods of implementing the example sintering control system 1700 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more devices (e.g., a multi-core processor in a single machine, multiple processors distributed across a server rack, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement one or more functions that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example processes of FIGS. 5, 6, and 14 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

FIG. 18 is a block diagram of an example processor platform 1800 structured to execute the instructions of FIGS. 5, 6, and/or 14 to implement the example sintering control system 1700, etc. The processor platform 1800 represents example processor circuitry and can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, or any other type of computing device.

The processor platform 1800 of the illustrated example includes a processor 1812. The processor 1812 of the illustrated example is hardware. For example, the processor 1812 can be implemented by one or more integrated circuits, logic circuits, microprocessors, GPUs, DSPs, or controllers from any desired family or manufacturer. The hardware processor may be a semiconductor based (e.g., silicon based) device.

The processor 1812 of the illustrated example includes a local memory 1813 (e.g., a cache and/or other memory circuitry). The processor 1812 of the illustrated example is in communication with a main memory/memory circuitry including a volatile memory 1814 and a non-volatile memory 1816 via a bus 1818. The volatile memory 1814 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 1816 may be implemented by flash memory and/or any other desired type of memory device/memory circuitry. Access to the main memory 1814, 1816 is controlled by a memory controller.

The processor platform 1800 of the illustrated example also includes an interface circuit 1820. The interface circuit 1820 may be implemented by any type of interface standard, such as an Ethernet interface, a universal serial bus (USB), a Bluetooth® interface, a near field communication (NFC) interface, and/or a PCI express interface.

In the illustrated example, one or more input devices 1822 are connected to the interface circuit 1820. The input device(s) 1822 permit(s) a user to enter data and/or commands into the processor 1812. The input device(s) can be implemented by, for example, an audio sensor, a microphone, a camera (still or video), a keyboard, a button, a mouse, a touchscreen, a track-pad, a trackball, and/or a voice recognition system.

One or more output devices 1824 are also connected to the interface circuit 1820 of the illustrated example. The output devices 1824 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, and/or speaker. The interface circuit 1820 of the illustrated example, thus, typically includes a graphics driver card, a graphics driver chip and/or a graphics driver processor.

The interface circuit 1820 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 1826. The communication can be via, for example, an Ethernet connection, a digital subscriber line (DSL) connection, a telephone line connection, a coaxial cable system, a satellite system, a line-of-site wireless system, a cellular system, etc.

The processor platform 1800 of the illustrated example also includes one or more mass storage devices 1828 for storing software and/or data. Examples of such mass storage devices 1828 include floppy disk drives, hard drive disks, compact disk drives, Blu-ray disk drives, redundant array of independent disks (RAID) systems, and digital versatile disk (DVD) drives.

The machine executable instructions 1832 of FIGS. 5, 6, and 14 may be stored in the mass storage device 1828, in the volatile memory 1814, in the non-volatile memory 1816, and/or on a removable non-transitory computer readable storage medium such as a CD or DVD.

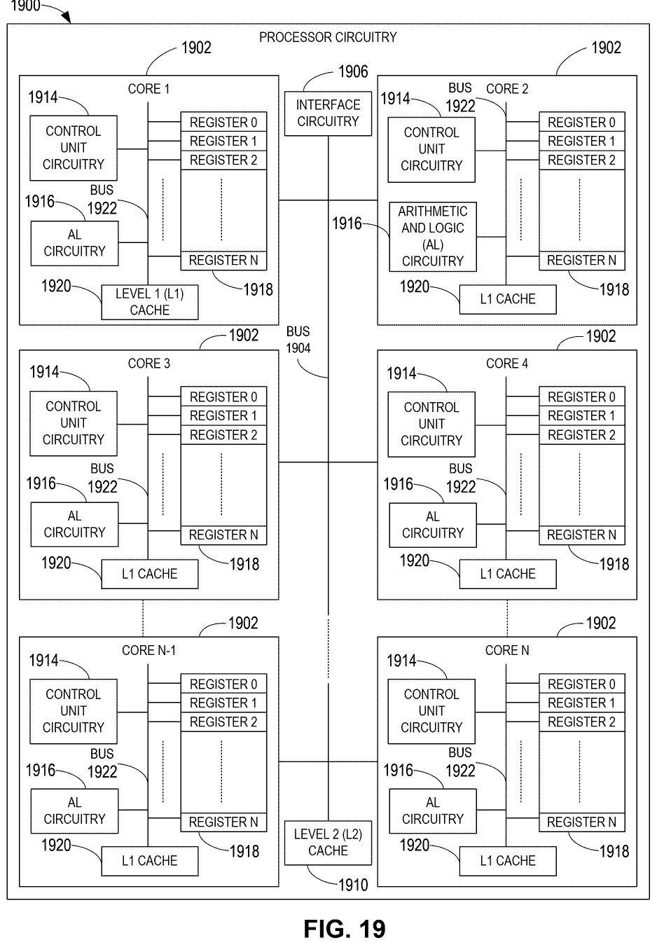

FIG. 19 is a block diagram of an example implementation of the processor circuitry 1812 of FIG. 18. In this example, the processor circuitry 1812 of FIG. 18 is implemented by a microprocessor 1900. For example, the microprocessor 1900 may implement multi-core hardware circuitry such as a CPU, a DSP, a GPU, an XPU, etc. Although it may include any number of example cores 1902 (e.g., 1 core), the microprocessor 1900 of this example is a multi-core semiconductor device including N cores. The cores 1902 of the microprocessor 1900 may operate independently or may cooperate to execute machine readable instructions. For example, machine code corresponding to a firmware program, an embedded software program, or a software program may be executed by one of the cores 1902 or may be executed by multiple ones of the cores 1902 at the same or different times. In some examples, the machine code corresponding to the firmware program, the embedded software program, or the software program is split into threads and executed in parallel by two or more of the cores 1902. The software program may correspond to a portion or all of the machine readable instructions and/or operations represented by the flowcharts of FIGS. 5, 6, and 14.

The cores 1902 may communicate by an example bus 1904. In some examples, the bus 1904 may implement a communication bus to effectuate communication associated with one(s) of the cores 1902. For example, the bus 1904 may implement at least one of an Inter-Integrated Circuit (I2C) bus, a Serial Peripheral Interface (SPI) bus, a PCI bus, or a PCIe bus. Additionally or alternatively, the bus 1904 may implement any other type of computing or electrical bus. The cores 1902 may obtain data, instructions, and/or signals from one or more external devices by example interface circuitry 1906. The cores 1902 may output data, instructions, and/or signals to the one or more external devices by the interface circuitry 1906. Although the cores 1902 of this example include example local memory 1920 (e.g., Level 1 (L1) cache that may be split into an L1 data cache and an L1 instruction cache), the microprocessor 1900 also includes example shared memory 1910 that may be shared by the cores (e.g., Level 2 (L2_cache)) for high-speed access to data and/or instructions. Data and/or instructions may be transferred (e.g., shared) by writing to and/or reading from the shared memory 1910. The local memory 1920 of each of the cores 1902 and the shared memory 1910 may be part of a hierarchy of storage devices including multiple levels of cache memory and the main memory (e.g., the main memory 1814, 1816 of FIG. 18). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1902 may be referred to as a CPU, DSP, GPU, etc., or any other type of hardware circuitry. Each core 1902 includes control unit circuitry 1914, arithmetic and logic (AL) circuitry (sometimes referred to as an ALU) 1916, a plurality of registers 1918, the L1 cache 1920, and an example bus 1922. Other structures may be present. For example, each core 1902 may include vector unit circuitry, single instruction multiple data (SIMD) unit circuitry, load/store unit (LSU) circuitry, branch/jump unit circuitry, floating-point unit (FPU) circuitry, etc. The control unit circuitry 1914 includes semiconductor-based circuits structured to control (e.g., coordinate) data movement within the corresponding core 1902. The AL circuitry 1916 includes semiconductor-based circuits structured to perform one or more mathematic and/or logic operations on the data within the corresponding core 1902. The AL circuitry 1916 of some examples performs integer based operations. In other examples, the AL circuitry 1916 also performs floating point operations. In yet other examples, the AL circuitry 1916 may include first AL circuitry that performs integer based operations and second AL circuitry that performs floating point operations. In some examples, the AL circuitry 1916 may be referred to as an Arithmetic Logic Unit (ALU). The registers 1918 are semiconductor-based structures to store data and/or instructions such as results of one or more of the operations performed by the AL circuitry 1916 of the corresponding core 1902. For example, the registers 1918 may include vector register(s), SIMD register(s), general purpose register(s), flag register(s), segment register(s), machine specific register(s), instruction pointer register(s), control register(s), debug register(s), memory management register(s), machine check register(s), etc. The registers 1918 may be arranged in a bank as shown in FIG. 19. Alternatively, the registers 1918 may be organized in any other arrangement, format, or structure including distributed throughout the core 1902 to shorten access time. The bus 1922 may implement at least one of an I2C bus, a SPI bus, a PCI bus, or a PCIe bus

Each core 1902 and/or, more generally, the microprocessor 1900 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1900 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

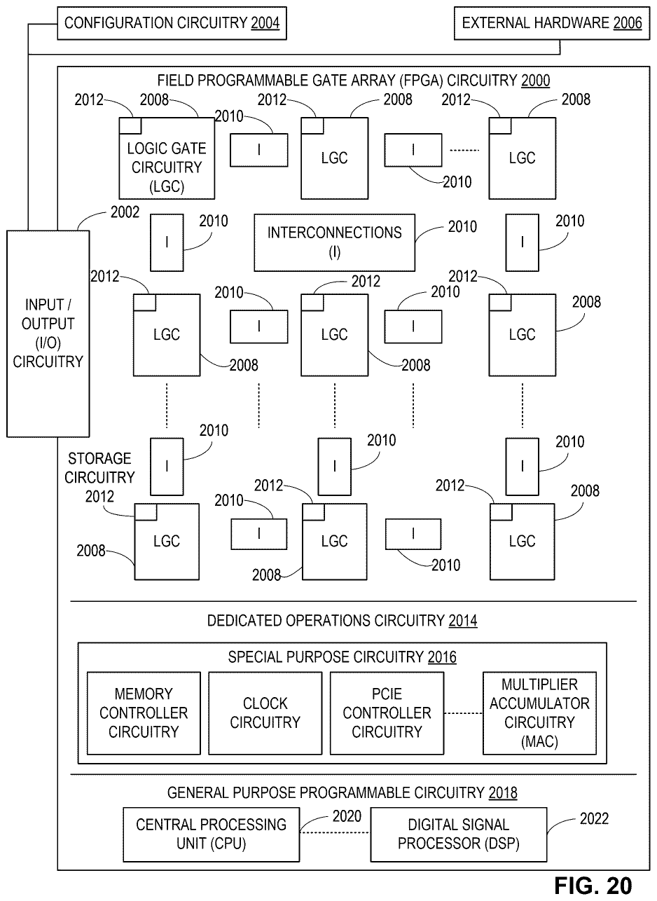

FIG. 20 is a block diagram of another example implementation of the processor circuitry 1812 of FIG. 18. In this example, the processor circuitry 1812 is implemented by FPGA circuitry 2000. The FPGA circuitry 2000 can be used, for example, to perform operations that could otherwise be performed by the example microprocessor 1900 of FIG. 19 executing corresponding machine readable instructions. However, once configured, the FPGA circuitry 2000 instantiates the machine readable instructions in hardware and, thus, can often execute the operations faster than they could be performed by a general purpose microprocessor executing the corresponding software.

More specifically, in contrast to the microprocessor 1900 of FIG. 19 described above (which is a general purpose device that may be programmed to execute some or all of the machine readable instructions represented by the flowcharts of FIGS. 5, 6, and 14 but whose interconnections and logic circuitry are fixed once fabricated), the FPGA circuitry 2000 of the example of FIG. 20 includes interconnections and logic circuitry that may be configured and/or interconnected in different ways after fabrication to instantiate, for example, some or all of the machine readable instructions represented by the flowcharts of FIGS. 5, 6, and 14. In particular, the FPGA 2000 may be thought of as an array of logic gates, interconnections, and switches. The switches can be programmed to change how the logic gates are interconnected by the interconnections, effectively forming one or more dedicated logic circuits (unless and until the FPGA circuitry 2000 is reprogrammed). The configured logic circuits enable the logic gates to cooperate in different ways to perform different operations on data received by input circuitry. Those operations may correspond to some or all of the software represented by the flowcharts of FIGS. 5, 6, and 14. As such, the FPGA circuitry 2000 may be structured to effectively instantiate some or all of the machine readable instructions of the flowcharts of FIGS. 5, 6, and 14 as dedicated logic circuits to perform the operations corresponding to those software instructions in a dedicated manner analogous to an ASIC. Therefore, the FPGA circuitry 2000 may perform the operations corresponding to the some or all of the machine readable instructions of FIGS. 5, 6, and 14 faster than the general purpose microprocessor can execute the same.

In the example of FIG. 20, the FPGA circuitry 2000 is structured to be programmed (and/or reprogrammed one or more times) by an end user by a hardware description language (HDL) such as Verilog. The FPGA circuitry 2000 of FIG. 20, includes example input/output (I/O) circuitry 2002 to obtain and/or output data to/from example configuration circuitry 2004 and/or external hardware (e.g., external hardware circuitry) 2006. For example, the configuration circuitry 2004 may implement interface circuitry that may obtain machine readable instructions to configure the FPGA circuitry 2000, or portion(s) thereof. In some such examples, the configuration circuitry 2004 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 2006 may implement the microprocessor 1900 of FIG. 19. The FPGA circuitry 2000 also includes an array of example logic gate circuitry 2008, a plurality of example configurable interconnections 2010, and example storage circuitry 2012. The logic gate circuitry 2008 and interconnections 2010 are configurable to instantiate one or more operations that may correspond to at least some of the machine readable instructions of FIGS. 5, 6, and 14 and/or other desired operations. The logic gate circuitry 2008 shown in FIG. 20 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 2008 to enable configuration of the electrical structures and/or the logic gates to form circuits to perform desired operations. The logic gate circuitry 2008 may include other electrical structures such as look-up tables (LUTs), registers (e.g., flip-flops or latches), multiplexers, etc.

The interconnections 2010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 2008 to program desired logic circuits.

The storage circuitry 2012 of the illustrated example is structured to store result(s) of the one or more of the operations performed by corresponding logic gates. The storage circuitry 2012 may be implemented by registers or the like. In the illustrated example, the storage circuitry 2012 is distributed amongst the logic gate circuitry 2008 to facilitate access and increase execution speed.

The example FPGA circuitry 2000 of FIG. 20 also includes example Dedicated Operations Circuitry 2014. In this example, the Dedicated Operations Circuitry 2014 includes special purpose circuitry 2016 that may be invoked to implement commonly used functions to avoid the need to program those functions in the field. Examples of such special purpose circuitry 2016 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 2000 may also include example general purpose programmable circuitry 2018 such as an example CPU 2020 and/or an example DSP 2022. Other general purpose programmable circuitry 2018 may additionally or alternatively be present such as a GPU, an XPU, etc., that can be programmed to perform other operations.

As such, the example FPGA circuitry 2000 can be used to (re) align and/or calibrate multi-laser alignment, stitching, other aspect of additive build execution, programming, etc., In certain examples, the FPGA circuitry 2000 can be used for scoring and data processing, together and/or in further combination with hyper-logging of data/events, etc.

Although FIGS. 19 and 20 illustrate two example implementations of the processor circuitry 1812 of FIG. 18, many other approaches are contemplated. For example, as mentioned above, modern FPGA circuitry may include an on-board CPU, such as one or more of the example CPU 2020 of FIG. 20. Therefore, the processor circuitry 1812 of FIG. 18 may additionally be implemented by combining the example microprocessor 1900 of FIG. 19 and the example FPGA circuitry 2000 of FIG. 20. In some such hybrid examples, a first portion of the machine readable instructions represented by the flowcharts of FIGS. 5, 6, and 14 may be executed by one or more of the cores 1902 of FIG. 19 and a second portion of the machine readable instructions represented by the flowcharts of FIGS. 5, 6, and 14 may be executed by the FPGA circuitry 2000 of FIG. 20. In certain examples, the FPGA circuitry 2000 is leveraged for edge computing. In certain examples, the FPGA circuitry 2000 is implemented in conjunction with the sintering control system 1700 for improved timeliness and/or data fusion. A TPM can also be incorporated to provide and enable hardware and/or software root of trust security for stronger compute/memory/CPU.GPU/etc., at a second/sub-second time constraint. The FPGA provides millisecond analysis and response such that some data can flow to the FGPA 2000 and some data flows to the sintering control system 1700 to provide a quicker response from the FPGA 2000 and possibly a slower response from the sintering control system 1700. In certain examples, a connection between the FPGA 2000 and the sintering control system 1700 allows insights from the FPGA 2000 to flow to the sintering control system 1700 to improve the detection and correction of errors by the sintering control system 1700. The FPGA 2000 and/or the sintering control system 1700 can utilize a TPM and/or other security element.

As such, certain examples determine appropriate sintering conditions and resulting material phase fractions for any alloy chemistries. The disclosed technologies can be used generally in fields such as manufacturing, transportation, or nuclear energy sector. More particularly, the disclosed technologies can be used to improve powder metallurgy techniques and/or binder jet additive manufacturing to produce a wide variety of parts. Typically, an alloy chemistry is well defined within a range by the ASTM specifications. While conventional processing such as casting and forging can accommodate subtle variations within the range, powder metallurgy is highly sensitive to these variations in the chemistry. Further, as the powders are produced, the manufacturers only guarantee that the powders will be within the ASTM specifications and there can be a batch-to-batch variability. This implies that even if the powders are sourced from the same manufacturer, each new batch needs its unique sintering process window. Currently, this is conducted by measuring the chemistry of the powder and using a thermodynamic database to determine the phase fractions such as liquid, or delta phase at high temperature and its evolution as it is cooled to room temperature, thereby mandating the need for expensive database and still be limited to tedious calculations. Further, the current methods are more descriptive in nature and do not allow for the fine tuning of alloy chemistry or even determining which alloying elements need to be controlled precisely versus which alloying elements have a minor impact on the process window. Certain examples provide an improved interface with powder manufacturers to obtain powder feedstock conducive for the end applications rather than using iteration-based approach to making end products.

Certain examples use high throughput CALPHAD data on an alloy such as Inconel 718, stainless steel 316, etc., to develop decision tree-based machine learning algorithms to predict the sintering window of binder jet additively manufactured parts. The machine learning algorithms predict the sintering window (e.g., solidus, liquidus, temperature to achieve 40% liquid, and distortion temperature) to improve configuration and operation of the sintering furnace. The models have a reasonable predictive capability to predict the sintering window of data sets not used for training and testing the models, even for Inconel 625 alloy system which has same elements as 718, but with different quantities. Systems and methods disclosed herein can apply to any alloy to predict the sintering window and configure sintering according to optimum sintering conditions.

Further examples and combinations thereof are provided by the subject matter of the following clauses:
Example 1 includes a sintering control apparatus including memory circuitry; instructions; and processor circuitry. The processor circuitry is to execute the instructions to at least: generate a plurality of material compositions within specified bounds; calculate a delta phase stability using thermo-kinetic calculations for the plurality of material compositions at a plurality of temperatures; train an artificial intelligence model using the delta phase stability, plurality of temperatures, and plurality of compositions; and configure a sintering process for a part formed of one of the plurality of material compositions using an inference output of the artificial intelligence model.

Examples provide the sintering control apparatus as part of an additive manufacturing machine and/or as part of an additive manufacturing system.

Example 2 includes the sintering control apparatus of any preceding clause, wherein generating the plurality of material compositions includes generating a plurality of stainless steel alloy compositions.

Example 3 includes the sintering control apparatus of any preceding clause, wherein generating the plurality of material compositions includes generating a plurality of nickel-chromium alloy compositions.

Example 4 includes the sintering control apparatus of any preceding clause, wherein the processor circuitry is to validate the artificial intelligence model.

Example 5 includes the sintering control apparatus of any preceding clause, wherein the processor circuitry is to deploy the artificial intelligence model to a controller to configure the sintering process.

Example 6 includes the sintering control apparatus of any preceding clause, wherein, for each of M generated plurality of material compositions, the processor circuitry is to determine, based on the thermo-kinetic calculations that simulate sintering, a corresponding set of temperatures {T_{SOL}, T_{40%}, T_{D}, T_{LIQ}}, where i=1 . . . M, T_{SOL} is a solidus temperature, T_{40%} is a 40% liquid-volume fraction temperature, T_{D} is a distortion temperature, and T_{LIQ} is a liquidus temperature.

Example 7 includes the sintering control apparatus of any preceding clause, wherein the processor circuitry is to: predict, based on the artificial intelligence model, a set of temperatures {T_{SOL}, T_{40%}, T_{D}, T_{LIQ}} for an alloy composition; and instruct a sintering furnace to sinter the part, made from the alloy composition, at a sintering temperature T_{S} that is greater than the predicted solidus temperature T_{SOL}_{ₑ} and less than the smaller of the predicted 40% liquid-volume fraction temperature T_{40%}_{ₑ} or the predicted distortion temperature T_{D}_{ₑ}:

Example 8 includes the sintering control apparatus of any preceding clause, wherein the artificial intelligence model is to predict a maximum sintering temperature T_{S}_{ₘₐₓ} and a minimum sintering temperature T_{S}_{ₘᵢₙ}, and wherein the processor circuitry is to trigger a corrective action when a predicted sintering temperature Tₛ_{ₑ} is outside a sintering window [T_{S}_{ₘᵢₙ}, T_{S}_{ₘₐₓ}].

Example 9 includes the sintering control apparatus of any preceding clause, wherein the delta phase stability includes a delta ferrite fraction.

Example 10 includes the sintering control apparatus of any preceding clause, wherein the plurality of material compositions include a plurality of stainless steel compositions, and wherein the processor circuitry is to: determine, based on thermo-kinetic calculations that simulate sintering, for each of N sintering-temperature values, sintered stainless steel's critical delta ferrite fraction f_{δ}_{_{i,j}} corresponding to each of M generated stainless steel compositions, where i=1 . . . M, j=1 . . . N; predict, based on the artificial intelligence model, a critical delta ferrite fraction foe of the stainless steel with a first stainless steel composition when sintered at a sintering temperature T_{S}_{_{new}}; obtain a target critical delta ferrite fraction range [f_{δ}_{ₘᵢₙ},f_{δ}_{ₘₐₓ}], and instruct a sintering furnace to sinter the part, made from stainless steel feedstock powder with the first stainless steel composition, at the sintering temperature T_{S}_{_{new}}, when the predicted critical delta ferrite fraction f_{δ}_{ₑ} is within a target critical delta ferrite fraction range [f_{δ}_{ₘᵢₙ},f_{δ}_{ₘₐₓ}]; and perform a corrective action, when the predicted critical delta ferrite fraction f_{δ}_{ₑ} is outside the target critical delta ferrite fraction range [f_{δ}_{ₘᵢₙ},f_{δ}_{ₘₐₓ}].

Example 11 is an additive manufacturing system including an additive manufacturing machine; a sintering furnace; and a controller to control operation of the sintering furnace. The controller is to control operation of the sintering furnace by at least: generating a plurality of material compositions within specified bounds; calculating a delta phase stability using thermo-kinetic calculations for the plurality of material compositions at a plurality of temperatures; training an artificial intelligence model using the delta phase stability, plurality of temperatures, and plurality of compositions; and configuring a sintering process for the part formed of one of the plurality of material compositions using an inference output of the artificial intelligence model.

Example 12 includes the additive manufacturing system of any preceding clause, wherein the plurality of material compositions include at least one of a plurality of stainless steel alloy compositions or a plurality of nickel alloy compositions.

Example 13 includes the additive manufacturing system of any preceding clause, wherein, for each of M generated plurality of material compositions, the controller is to determine, based on thermo-kinetic calculations that simulate sintering, a corresponding set of temperatures {T_{SOL}, T_{40%}, T_{D}, T_{LIQ}}, where i=1 . . . M, T_{SOL} is a solidus temperature, T_{40%} is a 40% liquid-volume fraction temperature, T_{D} is a distortion temperature, and T_{LIQ} is a liquidus temperature.

Example 14 includes the additive manufacturing system of any preceding clause, wherein the controller is to: predict, based on the artificial intelligence model, a set of temperatures {T_{SOL}, T_{40%}, T_{D}, T_{LIQ}} for an alloy composition; and instruct the sintering furnace to sinter the part, made from the alloy composition, at a sintering temperature T_{S} that is greater than the predicted solidus temperature T_{SOL}_{ₑ} and less than the smaller of the predicted 40% liquid-volume fraction temperature T_{40%}_{ₑ} or the predicted distortion temperature T_{D}_{ₑ}.

Example 15 includes the additive manufacturing system of any preceding clause, wherein the artificial intelligence model is to predict a maximum sintering temperature T_{S}_{ₘₐₓ} and a minimum sintering temperature T_{S}_{ₘᵢₙ}, and wherein the controller is to trigger a corrective action when a predicted sintering temperature Tₛ_{ₑ} is outside a sintering window [T_{S}_{ₘᵢₙ}, T_{S}_{ₘₐₓ}].

Example 16 includes the additive manufacturing apparatus of any preceding clause, wherein the delta phase stability includes a delta ferrite fraction.

Example 17 includes the additive manufacturing apparatus of any preceding clause, wherein the plurality of material compositions include a plurality of stainless steel compositions, and wherein the controller is to: determine, based on thermo-kinetic calculations that simulate sintering, for each of N sintering-temperature values, sintered stainless steel's critical delta ferrite fraction f_{δ}_{_{i,j}} corresponding to each of M generated stainless steel compositions, where i=1 . . . . M, j=1 . . . N; predict, based on the artificial intelligence model, a critical delta ferrite fraction foe of the stainless steel with a first stainless steel composition when sintered at a sintering temperature T_{S}_{_{new}}; obtain a target critical delta ferrite fraction range [f_{δ}_{ₘᵢₙ},f_{δ}_{ₘₐₓ}], and instruct a sintering furnace to sinter the part, made from stainless steel feedstock powder with the first stainless steel composition, at the sintering temperature T_{S}_{_{new}}, when the predicted critical delta ferrite fraction f₆₇ _{ₑ} is within a target critical delta ferrite fraction range [f_{δ}_{ₘᵢₙ},f_{δ}_{ₘₐₓ}]; and perform a corrective action, when the predicted critical delta ferrite fraction f_{δ}_{ₑ} is outside the target critical delta ferrite fraction range [f_{δ}_{ₘᵢₙ},f_{δ}_{ₘₐₓ}].

Example 18 includes the additive manufacturing system of any preceding clause, wherein the controller is implemented as a sintering furnace controller and an analytics computer.

Example 19 includes at least one non-transitory computer readable storage medium including instructions that, when executed, cause processor circuitry to at least: generate a plurality of material compositions within specified bounds; calculate a delta phase stability using thermo-kinetic calculations for the plurality of material compositions at a plurality of temperatures; train an artificial intelligence model using the delta phase stability, plurality of temperatures, and plurality of compositions; and configure a sintering process for a part formed of one of the plurality of material compositions using an inference output of the artificial intelligence model.

Example 20 includes the at least one non-transitory computer readable storage medium of any preceding clause, wherein the plurality of material compositions include a plurality of stainless steel compositions, and wherein the controller is to: determine, based on thermo-kinetic calculations that simulate sintering, for each of N sintering-temperature values, sintered stainless steel's critical delta ferrite fraction f₆₇ _{ₑ} corresponding to each of M generated stainless steel compositions, where i=1 . . . M, j=1 . . . N; predict, based on the artificial intelligence model, a critical delta ferrite fraction f_{δ}_{ₑ} of the stainless steel with a first stainless steel composition when sintered at a sintering temperature T_{S}_{_{new}}; obtain a target critical delta ferrite fraction range [f_{δ}_{ₘᵢₙ}, f_{δ}_{ₘₐₓ}], and instruct a sintering furnace to sinter the part, made from stainless steel feedstock powder with the first stainless steel composition, at the sintering temperature T_{S}_{_{new}}, when the predicted critical delta ferrite fraction f_{δ}_{ₑ} is within a target critical delta ferrite fraction range [f_{δ}_{ₘᵢₙ}, f_{δ}_{ₘₐₓ}]; and perform a corrective action, when the predicted critical delta ferrite fraction f_{δ}_{ₑ} is outside the target critical delta ferrite fraction range [f_{δ}_{ₘᵢₙ},f_{δ}_{ₘₐₓ}].

Example 21 is an example system for sintering a preform made from a feedstock powder of Nickel (Ni) alloy includes processor circuitry configured to perform operations including: obtaining standard-specified concentration ranges of constituents of the Ni alloy; for each constituent of the Ni alloy, generating constituent-concentration values that form a normal distribution within the respective constituent's standard-specified concentration range; generating M Ni alloy compositions by arbitrarily sampling the respective constituent-concentration normal distributions; for each of the M generated Ni alloy compositions, determining, based on thermo-kinetic calculations that simulate sintering, the corresponding sintered Ni alloy's set of critical temperatures {T_{SOL}, T_{40%}, T_{D}, T_{LIQ}}, where i=1 . . . M, T_{SOL} is a solidus temperature, T_{40%} is a 40% liquid-volume fraction temperature, T_{D} is a distortion temperature, and T_{LIQ} is a liquidus temperature; and training at least one machine learning (ML) model based on the generated Ni alloy compositions and the corresponding determined sets of critical temperatures. The example system also includes controller circuitry communicatively coupled with the processing module and sintering equipment, the controller circuitry configured to perform operations including: receiving a Ni alloy feedstock powder with a new Ni alloy composition; predicting, based on the trained model, a set of critical temperatures {T_{SOL}, T_{40%}, T_{D}, T_{LIQ}} for the Ni alloy with the new Ni alloy composition; and instructing the sintering equipment to sinter the preform, made from the Ni alloy feedstock powder with the new Ni alloy composition, at a sintering temperature T_{S} that is greater than the predicted solidus temperature T_{SOL}_{ₑ} and less than the smaller of the predicted 40% liquid-volume fraction temperature T_{40%}_{ₑ} or the predicted distortion temperature T_{D}_{ₑ}.

Example 22 includes the system of any preceding clause, wherein the Ni alloy includes a Ni-based superalloy.

Example 23 includes the system of any preceding clause, wherein the Ni-based superalloy includes one of Inconel 625 or Inconel 718.

Example 24 includes the system of any preceding clause, wherein the number M of generated Ni alloy compositions is in a range of 1,000 to 10,000.

Example 25 is a system for sintering a preform made from a feedstock powder of stainless steel including processing circuitry configured to perform operations including: obtaining standard-specified concentration ranges of constituents of the stainless steel; for each constituent of the stainless steel, generating constituent concentration values that form a normal distribution within the respective constituent's standard-specified concentration range; generating M stainless steel compositions by arbitrarily sampling the respective constituent-concentration normal distributions; obtaining a sequence of N sintering-temperature values within an operational-temperature range [Tₒₚ_{ₘᵢₙ}, Tₒₚ_{ₘₐₓ}]; determining, based on thermo-kinetic calculations that simulate sintering, for each of the N sintering-temperature values, the sintered stainless steel's critical delta ferrite fraction f_{δ}_{_{i,j}} corresponding to each of the M generated stainless steel compositions, where i=1 . . . M, j=1 . . . N; and training at least one machine learning (ML) model based on the determined sintered stainless steel's critical delta ferrite fractions and the corresponding combinations of the generated stainless steel compositions and the sintering-temperature values. The example system also includes a controller module communicatively coupled with the processing module and sintering equipment, the controller module configured to perform operations including: receiving a stainless steel feedstock powder with a new stainless steel composition and a new sintering temperature T_{S}_{_{new}} predicting, based on the trained model, a critical delta ferrite fraction f_{δ}_{ₑ} of the stainless steel with the new stainless steel composition when sintered at the new sintering temperature T_{S}_{_{new}}; obtaining a target critical delta ferrite fraction range [f_{δ}_{ₘᵢₙ},f_{δ}_{ₘₐₓ}], and instructing the sintering equipment to sinter the preform, made from the stainless steel feedstock powder with the new stainless steel composition, at the new sintering temperature T_{S}_{_{new}}, if the predicted critical delta ferrite fraction f_{δ}_{ₑ} is within the target critical delta ferrite fraction range [f_{δ}_{ₘᵢₙ} f_{δ}_{ₘₐₓ}]; or performing a corrective action, if the predicted critical delta ferrite fraction f_{δ}_{ₑ} is outside the target critical delta ferrite fraction range [f_{δ}_{ₘᵢₙ},f_{δ}_{ₘₐₓ}].

Example 26 is a system for sintering a preform made from a feedstock powder of stainless steel including a processing circuit configured to perform operations including: obtaining standard-specified concentration ranges of constituents of the stainless steel; for each constituent of the stainless steel, generating constituent-concentration values that form a normal distribution within the respective constituent's standard-specified concentration range; generating M stainless steel compositions by arbitrarily sampling the respective constituent-concentration normal distributions; obtaining a sequence of N sintering-temperature values within an operational-temperature range [Tₒₚ_{ₘᵢₙ}, Tₒₚ_{ₘₐₓ}]; determining, based on thermo-kinetic calculations that simulate sintering, for each of the N sintering-temperature values, the sintered stainless steel's critical delta ferrite fraction f_{δ}_{_{i,j}} corresponding to each of the M generated stainless steel compositions, where i=1 . . . M, j=1 . . . N; training at least one machine learning (ML) model based on the determined sintered stainless steel's critical delta ferrite fractions and the corresponding combinations of the generated stainless steel compositions and the sintering-temperature values; and determining a sintering window [T_{S}_{ₘᵢₙ}, T_{S}_{ₘₐₓ}] within the operational-temperature range [Tₒₚ_{ₘᵢₙ}, Tₒₚ_{ₘₐₓ}], wherein compositions of stainless steels sintered based on the sintering window correspond to a target critical delta ferrite fraction range [f_{δ}_{ₘᵢₙ},f_{δ}_{ₘₐₓ}]. The system also includes a controller circuit communicatively coupled with the processing circuit and sintering equipment, the controller module configured to perform operations including: receiving a stainless steel feedstock powder with a new stainless steel composition; predicting, based on the trained model, a sintering temperature T_{S}_{ₑ} that causes the sintered stainless steel with the new stainless steel composition to have a predicted critical delta ferrite fraction f_{δ}_{ₑ} within the target critical delta ferrite fraction range [f_{δ}_{ₘᵢₙ},f_{δ}_{ₘₐₓ}], and instructing the sintering equipment to sinter the preform, made from the stainless steel feedstock powder with the new stainless steel composition, at the predicted sintering temperature T_{S}_{ₑ}, if the predicted sintering temperature T_{S}_{ₑ} is within the sintering window [T_{S}_{ₘᵢₙ}, T_{S}_{ₘₐₓ}]; or performing a corrective action, if the predicted sintering temperature T_{S}_{ₑ} is outside the sintering window [T_{S}_{ₘᵢₙ}, T_{S}_{ₘₐₓ}].

Example 27 includes the system of any preceding clause, wherein the stainless steel includes one of 316 stainless steel or 304 stainless steel.

Example 28 includes the system of any preceding clause, wherein the number M of generated stainless steel compositions is in a range of 1,000 to 10,000.

Example 29 includes the system of any preceding clause, wherein the N sintering-temperature values are separated by a temperature interval

$$ΔT = \frac{{T}_{{op}_{max}} - {T}_{{op}_{min}}}{N} ,$$

and N is selected such that the temperature interval ΔT is a fraction of 1% to 20% of (Tₒₚ_{ₘₐₓ}−Tₒₚ_{ₘᵢₙ}.

Example 30 includes the system of any preceding clause, wherein the thermo-kinetic calculations that simulate sintering comprise CALculation of PHAse Diagrams (CALPHAD). The system of any one of the previous claims, wherein the operation of training (130/330) at least one ML model comprises training one of a random forest regression, a gradient boosting regression, an XGBoost regression, or a neural network regression.

Example 31 includes the system of any preceding clause, including the sintering equipment.

Example 31 includes the system of any preceding clause, wherein the sintering equipment comprises the controller module.

Example 32 includes the system of any preceding clause, wherein the controller module comprises a user interface, and at least the new alloy composition of the alloy feedstock powder is received as input provided by a user in the user interface.

Example 33 includes the system of any preceding clause, wherein the processing module comprises one or more of a personal computer, or a supercomputer system.

In the example of any preceding clause, the artificial intelligence model can include one or more of a random forest regression model, a gradient boosting regression model, an XGBoost regression model, or a neural network regression model. In the example of any preceding clause, the artificial intelligence model is trained based on one or more of material composition, correlation between composition and temperature, or actual temperature versus predicted temperature (e.g., for solidus temperature, liquidus temperature, distortion temperature, temperature to find 40% liquid). In the example of any preceding clause, hyperparameters are tuned for the artificial intelligence model based on a cross validation score.

While particular examples have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A sintering control apparatus comprising:
memory circuitry;
instructions in the memory circuitry; and
processor circuitry to execute the instructions to at least:
generate a plurality of material compositions within specified bounds;
calculate a delta phase stability using thermo-kinetic calculations for the plurality of material compositions at a plurality of temperatures;
train an artificial intelligence model using the delta phase stability, the plurality of temperatures, and the plurality of compositions; and
configure a sintering process for a part formed of one of the plurality of material compositions using an inference output of the artificial intelligence model.

2. The sintering control apparatus of claim 1, wherein generating the plurality of material compositions includes generating a plurality of stainless steel alloy compositions.

3. The sintering control apparatus of claim 1, wherein generating the plurality of material compositions includes generating a plurality of nickel-chromium alloy compositions.

4. The sintering control apparatus of claim 1, wherein the processor circuitry is to validate the artificial intelligence model.

5. The sintering control apparatus of claim 1, wherein the processor circuitry is to deploy the artificial intelligence model to a controller to configure the sintering process.

6. The sintering control apparatus of claim 1, wherein, for each of M generated plurality of material compositions, the processor circuitry is to determine, based on the thermo-kinetic calculations that simulate sintering, a corresponding set of temperatures {T_{SOL}, T_{40%}, T_{D}, T_{LIQ}}, where i=1 . . . M, T_{SOL} is a solidus temperature, T_{40%} is a 40% liquid-volume fraction temperature, T_{D} is a distortion temperature, and T_{LIQ} is a liquidus temperature.

7. The sintering control apparatus of claim 6, wherein the processor circuitry is to:
predict, based on the artificial intelligence model, a set of temperatures {T_{SOL}, T_{40%}, T_{D}, T_{LIQ}} for an alloy composition; and
instruct a sintering furnace to sinter the part, made from the alloy composition, at a sintering temperature T_{S} that is greater than the predicted solidus temperature T_{SOL}_{ₑ} and less than the smaller of the predicted 40% liquid-volume fraction temperature T_{40%}_{ₑ} or the predicted distortion temperature T_{D}_{ₑ}.

8. The sintering control apparatus of claim 7, wherein the artificial intelligence model is to predict a maximum sintering temperature T_{S}_{ₘₐₓ} and a minimum sintering temperature T_{S}_{ₘᵢₙ} and wherein the processor circuitry is to trigger a corrective action when a predicted sintering temperature T_{S}_{ₑ} is outside a sintering window [T_{S}_{ₘᵢₙ}, T_{S}_{ₘₐₓ}].

9. The sintering control apparatus of claim 1, wherein the delta phase stability includes a delta ferrite fraction.

10. The sintering control apparatus of claim 9, wherein the plurality of material compositions include a plurality of stainless steel compositions, and wherein the processor circuitry is to:
determine, based on thermo-kinetic calculations that simulate sintering, for each of N sintering-temperature values, a critical delta ferrite fraction f_{δ}_{_{i,j}} of sintered stainless steel corresponding to each of M generated stainless steel compositions, where i=1 . . . M, j=1 . . . N;
predict, based on the artificial intelligence model, a critical delta ferrite fraction f_{δ}_{ₑ} of the stainless steel with a first stainless steel composition when sintered at a sintering temperature T_{S}_{_{new}};
obtain a target critical delta ferrite fraction range [f_{δ}_{ₘᵢₙ},f_{δ}_{ₘₐₓ}];
instruct a sintering furnace to sinter the part, made from stainless steel feedstock powder with the first stainless steel composition, at the sintering temperature T_{S}_{_{new}}, when the predicted critical delta ferrite fraction f_{δ}_{ₑ} is within the target critical delta ferrite fraction range [f_{δ}_{ₘᵢₙ}, f_{δ}_{ₘₐₓ}]; and
perform a corrective action, when the predicted critical delta ferrite fraction f_{δ}_{ₑ} is outside the target critical delta ferrite fraction range [f_{δ}_{ₘᵢₙ},f_{δ}_{ₘₐₓ}].

11. An additive manufacturing system comprising:
an additive manufacturing machine;
a sintering furnace; and
a controller to control operation of the sintering furnace by at least:
generating a plurality of material compositions within specified bounds;
calculating a delta phase stability using thermo-kinetic calculations for the plurality of material compositions at a plurality of temperatures;
training an artificial intelligence model using the delta phase stability, the plurality of temperatures, and the plurality of compositions; and
configuring a sintering process for a part formed of one of the plurality of material compositions using an inference output of the artificial intelligence model.

12. The additive manufacturing system of claim 11, wherein generating the plurality of material compositions includes generating at least one of a plurality of stainless steel alloy compositions or a plurality of nickel alloy compositions.

13. The additive manufacturing system of claim 11, wherein, for each of M generated plurality of material compositions, the controller is to determine, based on the thermo-kinetic calculations that simulate sintering, a corresponding set of temperatures {T_{SOL}, T_{40%}, T_{D}, T_{LIQ}}, where i=1 . . . M, T_{SOL} is a solidus temperature, T_{40%} is a 40% liquid-volume fraction temperature, T_{D} is a distortion temperature, and T_{LIQ} is a liquidus temperature.

14. The additive manufacturing system of claim 13, wherein the controller is to:
predict, based on the artificial intelligence model, a set of temperatures {T_{SOL}, T_{40%}, T_{D}, T_{LIQ}} for an alloy composition; and
instruct the sintering furnace to sinter the part, made from the alloy composition, at a sintering temperature T_{S} that is greater than the predicted solidus temperature T_{SOL}_{ₑ} and less than the smaller of the predicted 40% liquid-volume fraction temperature T_{40%}_{ₑ} or the predicted distortion temperature T_{D}_{ₑ}.

15. The additive manufacturing system of claim 14, wherein the artificial intelligence model is to predict a maximum sintering temperature T_{S}_{ₘₐₓ} and a minimum sintering temperature T_{S}_{ₘᵢₙ}, and wherein the controller is to trigger a corrective action when a predicted sintering temperature T_{S}_{ₑ} is outside a sintering window [T_{S}_{ₘᵢₙ}, T_{S}_{ₘₐₓ}].

16. The additive manufacturing system of claim 11, wherein the delta phase stability includes a delta ferrite fraction.

17. The additive manufacturing system of claim 16, wherein the plurality of material compositions include a plurality of stainless steel compositions, and wherein the controller is to:
determine, based on the thermo-kinetic calculations that simulate sintering, for each of N sintering-temperature values, a critical delta ferrite fraction f_{δ}_{_{i,j}} of sintered stainless steel corresponding to each of M generated stainless steel compositions, where i=1 . . . M, j=1 . . . N;
predict, based on the artificial intelligence model, a critical delta ferrite fraction f_{δ}_{ₑ} of the stainless steel with a first stainless steel composition when sintered at a sintering temperature T_{S}_{_{new}};
obtain a target critical delta ferrite fraction range [f_{δ}_{ₘᵢₙ},f_{δ}_{ₘₐₓ}];
instruct the sintering furnace to sinter the part, made from stainless steel feedstock powder with the first stainless steel composition, at the sintering temperature T_{S}_{_{new}}, when the predicted critical delta ferrite fraction f_{δ}_{ₑ} is within the target critical delta ferrite fraction range [f_{δ}_{ₘᵢₙ}, f_{δ}_{ₘₐₓ}]; and
perform a corrective action, when the predicted critical delta ferrite fraction f_{δ}_{ₑ} is outside the target critical delta ferrite fraction range [f_{δ}_{ₘᵢₙ},f_{δ}_{ₘₐₓ}].

18. The additive manufacturing system of claim 11, wherein the controller is implemented as a sintering furnace controller and an analytics computer.

19. At least one non-transitory computer readable storage medium comprising instructions that, when executed, cause processor circuitry to at least:
generate a plurality of material compositions within specified bounds;
calculate a delta phase stability using thermo-kinetic calculations for the plurality of material compositions at a plurality of temperatures;
train an artificial intelligence model using the delta phase stability, the plurality of temperatures, and the plurality of compositions; and
configure a sintering process for a part formed of one of the plurality of material compositions using an inference output of the artificial intelligence model.

20. The at least one non-transitory computer readable storage medium of claim 19, wherein the plurality of material compositions include a plurality of stainless steel compositions, and wherein the processor circuitry is to:
determine, based on the thermo-kinetic calculations that simulate sintering, for each of N sintering-temperature values, a critical delta ferrite fraction f_{δ}_{_{i,j}} of sintered stainless steel corresponding to each of M generated stainless steel compositions, where i=1 . . . M, j=1 . . . N;
predict, based on the artificial intelligence model, a critical delta ferrite fraction f_{δ}_{ₑ} of the stainless steel with a first stainless steel composition when sintered at a sintering temperature T_{S}_{_{new}};
obtain a target critical delta ferrite fraction range [f_{δ}_{ₘᵢₙ},f_{δ}_{ₘₐₓ}];
instruct a sintering furnace to sinter the part, made from stainless steel feedstock powder with the first stainless steel composition, at the sintering temperature T_{S}_{_{new}}, when the predicted critical delta ferrite fraction f_{δ}_{ₑ} is within the target critical delta ferrite fraction range [f_{δ}_{ₘᵢₙ}, f_{δ}_{ₘₐₓ}]; and
perform a corrective action, when the predicted critical delta ferrite fraction f_{δ}_{ₑ} is outside the target critical delta ferrite fraction range [f_{δ}_{ₘᵢₙ},f_{δ}_{ₘₐₓ}].
